(19) United States
(12) Patent Application Publication
(10) Pub. No.: US 2025/0167668 A1
(43) Pub. Date: May 22, 2025

(54) OVERHEAT PROTECTION CONTROL DEVICE FOR POWER CONVERTER

(71) Applicant: Mitsubishi Electronic Corporation, Tokyo (JP)

(72) Inventors: Masashi NAWA, TOKYO (JP); Takeru OKABE, TOKYO (JP); Shinichiro YOTSUMOTO, TOKYO (JP); Koki AMANO, TOKYO (JP)

(73) Assignee: Mitsubishi Electronic Corporation, Tokyo (JP)

(21) Appl. No.: 18/839,579

(22) PCT Filed: Mar. 7, 2022
(86) PCT No.: PCT/JP2022/009716

§ 371 Date: Aug. 19, 2024

(51) Int. Cl. H02M 1/32; H02M 7/5387

(52) U.S. Cl. CPC H02M 1/327; H02M 7/53871

(57) ABSTRACT

In an overheat protection control device for a power converter, a heat amount calculation unit adds a value of a product of a current squared and time to a heat amount-equivalent value of a last time when an electric power is equal to or more than a first determination output value, and, when the electric power is less than the first determination output value, subtracts a subtraction value from the heat amount-equivalent value of the last time. When a heat amount-equivalent value calculated by the heat amount calculation unit becomes a first determination heat amount-equivalent value or larger, a power command unit restricts the electric power in the power converter, and lifts the restriction on the electric power in the power converter when the heat amount-equivalent value calculated by the heat amount calculation unit becomes a second determination heat amount-equivalent value or smaller.

### TECHNICAL FIELD

This disclosure relates to an overheat protection control device for a power converter.

### BACKGROUND ART

In a power conversion device of the related art, a control unit electronically adds a weighting value based on a detected current of a current detector to an integrated value of a built-in electronic counter in overload operation of an AC electric motor. When the AC electric motor is not in overload operation, the control unit subtracts a weighting value determined in light of a value that is a product calculated by multiplying the square of the detected current of the current detector in overload operation by time from the integrated value of the electronic counter.

When the integrated value of the electronic counter reaches a set value regarding a heat time limit characteristic, the control unit sends a signal for stopping an inverter to a drive circuit, to thereby stop the AC electric motor (see, for example, Patent Literature 1).

### CITATION LIST

### Patent Literature

[PTL 1] JP 5520639 B2

### SUMMARY OF INVENTION

### Technical Problem

In the power conversion device of the related art as described above, operation of the inverter is stopped in overheat protection, and output to the inverter is accordingly restricted to the level of over-protection, possibly resulting in a low operation efficiency of the inverter.

This disclosure has been made to solve the problem described above, and it is an object of this disclosure to obtain an overheat protection control device for a power converter that is capable of reducing a drop in operation efficiency of the power converter by reducing excessive protection of the power converter.

### Solution to Problem

According to one embodiment of this disclosure, there is provided an overheat protection control device for a power converter, including: a power calculation unit configured to calculate an electric power in the power converter; a heat amount calculation unit configured to calculate a heat amount-equivalent value, based on the electric power calculated by the power calculation unit and a first determination output value which is a threshold value of the electric power; and a power command unit configured to control the electric power in the power converter, based on the heat amount-equivalent value calculated by the heat amount calculation unit. The heat amount calculation unit is configured to: add, when the electric power is equal to or more than the first determination output value, to the heat amount-equivalent value of a last time, a value of a product of a current squared and time which is a value obtained by multiplying a square of an electric current flowing in a conductor by the time, the conductor being connected to the power converter; and subtract, when the electric power is less than the first determination output value, a subtraction value from the heat amount-equivalent value of the last time. The power command unit is configured to: restrict the electric power in the power converter when the heat amount-equivalent value calculated by the heat amount calculation unit becomes a first determination heat amount-equivalent value or larger; and lift the restriction on the electric power in the power converter when the heat amount-equivalent value calculated by the heat amount calculation unit becomes a second determination heat amount-equivalent value or smaller, the second determination heat amount-equivalent value being smaller than the first determination heat amount-equivalent value.

### Advantageous Effects of Invention

According to the overheat protection control device for a power converter of this disclosure, a drop in operation efficiency of the power converter can be reduced by reducing excessive protection of the power converter.

### BRIEF DESCRIPTION OF DRAWINGS

FIG. 1 is a configuration diagram for illustrating a vehicle driving system in a first embodiment of this disclosure.

FIG. 2 is a graph for showing an example of a relationship between a heat amount-equivalent value and a temperature.

FIG. 3 is a graph for showing an example of a state in which a DC power restriction value gradually increases when the DC power restriction value is switched by a DC power command unit of FIG. 1.

FIG. 4 is a graph for showing an example of a state in which the DC power restriction value gradually decreases when the DC power restriction value is switched by the DC power command unit of FIG. 1.

FIG. 5 is a block diagram for illustrating an essential part of an overheat protection control device of FIG. 1.

FIG. 6 is a block diagram for illustrating an example of a detailed configuration of a maximum current adjustment unit of FIG. 5.

FIG. 7 is a graph for showing a first example of a relationship between input and output in the maximum current adjustment unit of FIG. 6.

FIG. 8 is a graph for showing a second example of the relationship between input and output in the maximum current adjustment unit of FIG. 6.

FIG. 9 is a table for showing an example of a method of obtaining an upper limit value of allowable torque in an allowable torque calculation unit of FIG. 5.

FIG. 10 is a table for showing an example of a method of obtaining a lower limit value of the allowable torque in the allowable torque calculation unit of FIG. 5.

FIG. 11 is a flow chart for illustrating a first half of operation of the overheat protection control device of FIG. 1.

FIG. 12 is a flow chart for illustrating a second half of the operation of the overheat protection control device of FIG. 1.

FIG. 13 is a table for showing an example of a relationship between a water temperature, a DC power, and a first determination heat amount-equivalent value.

FIG. 14 is a graph for showing the relationship between the water temperature, the DC power, and the first determination heat amount-equivalent value which corresponds to FIG. 13.

FIG. 15 is a table for showing an example of a relationship between the water temperature and a second determination heat amount-equivalent value.

FIG. 16 is a graph for showing the relationship between the water temperature and the second determination heat amount-equivalent value which corresponds to FIG. 15.

FIG. 17 is a table for showing an example of a relationship between the water temperature, the DC power, and a subtraction value.

FIG. 18 is a graph for showing the relationship between the water temperature, the DC power, and the subtraction value which corresponds to FIG. 17.

FIG. 19 is a graph for showing results of measuring changes with time of a temperature of a conductor at a time when the water temperature is high and a time when the water temperature is low.

FIG. 20 is a table for showing an example of a relationship between the water temperature and a restriction-activated DC power restriction value.

FIG. 21 is a graph for showing the relationship between the water temperature and the restriction-activated DC power restriction value which corresponds to FIG. 20.

FIG. 22 are timing charts for illustrating overheat protection operation in the first embodiment.

FIG. 23 is a block diagram for illustrating an essential part of an overheat protection control device according to a second embodiment of this disclosure.

FIG. 24 is a graph for showing an example of a relationship between the rpm and an AC current.

FIG. 25 is a graph for showing an example of a relationship of the rpm to the first determination heat amount-equivalent value and the second determination heat amount-equivalent value.

FIG. 26 is a block diagram for illustrating an essential part of an overheat protection control device according to a third embodiment of this disclosure.

FIG. 27 is a graph for showing an example of a relationship between the AC current and a DC current.

FIG. 28 is a graph for showing an example of a relationship of the AC current to the first determination heat amount-equivalent value and the second determination heat amount-equivalent value.

FIG. 29 is a configuration diagram for illustrating a first example of a processing circuit that implements functions of an inverter control device and functions of the overheat protection control device of the first embodiment to the third embodiment.

FIG. 30 is a configuration diagram for illustrating a second example of a processing circuit that implements the functions of the inverter control device and the functions of the overheat protection control device of the first embodiment to the third embodiment.

### DESCRIPTION OF EMBODIMENTS

Now, embodiments of this disclosure are described with reference to the drawings.

### First Embodiment

### <Vehicle Driving System>

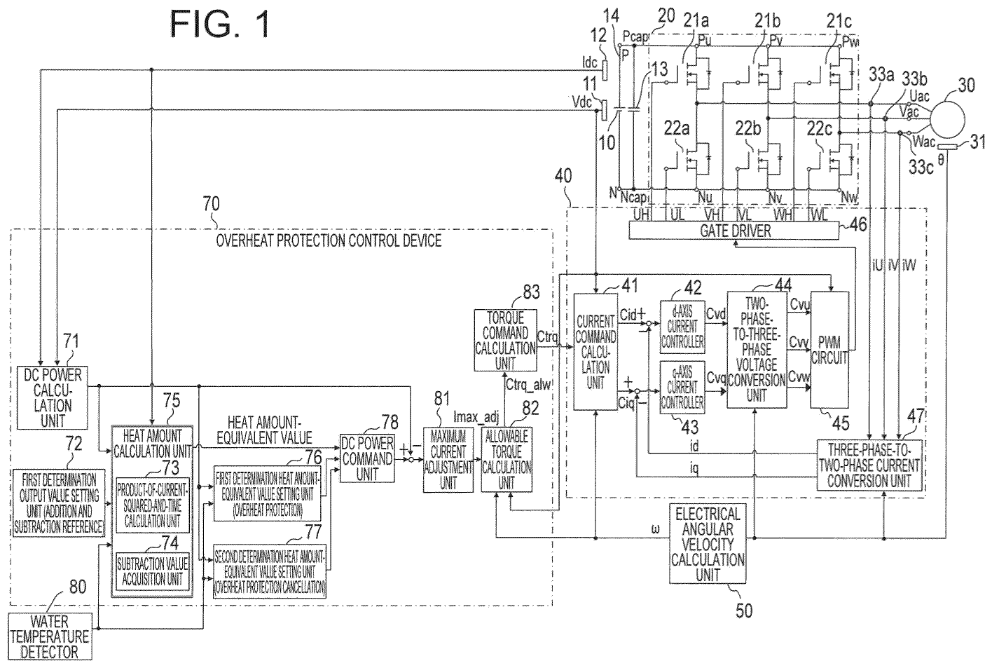

FIG. 1 is a configuration diagram for illustrating a vehicle driving system in a first embodiment of this disclosure. In the drawing, the vehicle driving system includes a DC power source 10, a voltage detector 11, a current detector 12, a smoothing capacitor 13, an inverter 20 serving as a power converter, an AC rotary electric machine 30, a magnetic pole position detector 31, a first current sensor 33a, a second current sensor 33b, a third current sensor 33c, an inverter control device 40, an electrical angular velocity calculation unit 50, an overheat protection control device 70, and a water temperature detector 80.

The DC power source 10 is a power source capable of charging and discharging. The DC power source 10 exchanges electric power with the AC rotary electric machine 30 via the inverter 20. The DC power source 10 includes a high-voltage-side node P and a low-voltage-side node N.

The smoothing capacitor 13 is connected between the high-voltage-side node P and the low-voltage-side node N at a high-voltage-side connection point Pcap and a low-voltage-side connection point Ncap. A step-up converter (not shown) may be connected between the high-voltage-side node P and the inverter 20. In this case, a DC voltage supplied from the DC power source 10 is stepped up by DC/DC conversion.

The voltage detector 11 detects a DC voltage Vdc of the DC power source 10. That is, the voltage detector 11 detects a voltage applied to a conductor 14 connected to the inverter 20, and outputs a detected voltage value as the DC voltage Vdc.

Specifically, the voltage detector 11 outputs, as the DC voltage Vdc, an inter-terminal voltage between the high-voltage-side node P and the low-voltage-side node N. The voltage detector 11 may output a voltage between the high-voltage-side connection point Pcap and the low-voltage-side connection point Ncap as the DC voltage Vdc.

The current detector 12 detects a DC current Idc flowing between the DC power source 10 and the inverter 20. That is, the current detector 12 detects an electric current flowing in the conductor 14, and outputs a detected current value as the DC current Idc.

Specifically, the current detector 12 outputs, as the DC current Idc, an electric current between the high-voltage-side node P and a plurality of terminals Pu, Pv, and Pw. Alternatively, the current detector 12 outputs, as the DC current Idc, an electric current between the low-voltage-side node N and a plurality of terminals Nu, Nv, and Nw.

Assuming that a DC power (Vdc×Idc) and an AC power (Vac×Iac) are equal to each other, the DC current Idc may be estimated by the following equation.

$$I dc = ( V ac \times I ac ) / V dc \qquad ( 1 )$$

In this case, the AC current Iac may be estimated from a d-axis current id and a q-axis current iq by the following equation.

$$I a c = \sqrt{i {d}^{2} + i {q}^{2}} \qquad ( 2 )$$

The AC voltage Vac is calculable by, in a case of a U-V line voltage between U and V, for example, Uac-Vac. The AC voltage Vac is calculable by Vac-Wac in a case of a V-W line voltage between V and W. The AC voltage Vac is calculable by Wac-Uac in a case of a W-U line voltage between W and U. The AC voltage Vac may also be obtained from an average of a plurality of line voltages.

The water temperature detector 80 detects a temperature of cooling water, that is, a water temperature, of the inverter 20.

### <Inverter>

The inverter 20 includes a plurality of switching elements. Through switching operation of the plurality of switching elements, the inverter 20 performs DC-to-AC conversion on the DC voltage from the DC power source 10. The AC voltage obtained by the DC-to-AC conversion is applied to the AC rotary electric machine 30.

The plurality of switching elements include a plurality of switching elements on an upper arm side and a plurality of switching elements on a lower arm side. As the plurality of switching elements on the upper arm side, a first upper arm switching element 21a, a second upper arm switching element 21b, and a third upper arm switching element 21c are used. As the plurality of switching elements on the lower arm side, a first lower arm switching element 22a, a second lower arm switching element 22b, and a third lower arm switching element 22c are used.

### <AC Rotary Electric Machine>

The AC rotary electric machine 30 controls, with the AC voltage from the inverter 20 applied thereto, a driving force and a braking force of a vehicle. The vehicle is an electrified vehicle, such as an electric vehicle or a hybrid vehicle. The AC rotary electric machine 30 is, for example, a permanent magnet synchronous electric motor. In the first embodiment, an AC rotary electric machine equipped with three-phase armature winding is used as the AC rotary electric machine 30. However, the number of phases of the AC rotary electric machine 30 is not limited to three, and may be any appropriate number.

The magnetic pole position detector 31 detects a position of a magnetic pole of the AC rotary electric machine 30. The magnetic pole position detector 31 includes, for example, a Hall effect sensor, a resolver, or an encoder. The magnetic pole position detector 31 detects a rotation angle of the magnetic pole in relation to a reference rotational position of a rotor of the AC rotary electric machine 30, and outputs, as a magnetic pole position θ, a signal indicating a detection value of the detected rotation angle. The magnetic pole position θ indicates a rotation angle of the q-axis. The reference rotational position of the rotor is set to any appropriate position in advance.

The electrical angular velocity calculation unit 50 calculates an electrical angular velocity ω with use of the magnetic pole position θ output from the magnetic pole position detector 31. The electrical angular velocity calculation unit 50 may use a Hall effect sensor, an encoder, or the like to directly detect the electrical angular velocity ω of the AC rotary electric machine 30.

The first current sensor 33a detects a current amount iU of an electric current flowing in the U phase of the AC rotary electric machine 30. The second current sensor 33b detects a current amount iV of an electric current flowing in the V phase of the AC rotary electric machine 30. The third current sensor 33c detects a current amount iW of an electric current flowing in the W phase of the AC rotary electric machine 30.

The number of current sensors may be two. In this case, only current amounts of two phases are detected, and a current amount of the remaining one phase is obtained by calculation from the detected current amounts of the two phases.

### <Inverter Control Device>

The inverter control device 40 controls the switching operation of the plurality of switching elements included in the inverter 20. The inverter control device 40 thus adjusts electric potentials of connection nodes Uac, Vac, and Wac at which the inverter 20 and the AC rotary electric machine 30 are connected to each other, to thereby control amounts of currents flowing in the AC rotary electric machine 30.

The inverter control device 40 includes, as function blocks, a current command calculation unit 41, a d-axis current controller 42, a q-axis current controller 43, a two-phase-to-three-phase voltage conversion unit 44, a pulse width modulation (PWM) circuit 45, a gate driver 46, and a three-phase-to-two-phase current conversion unit 47. The inverter control device 40 controls the inverter 20 through d-q vector control, to thereby control rotation of the AC rotary electric machine 30.

A torque command is input to the current command calculation unit 41 from the overheat protection control device 70. The torque command is a command about torque to be generated by the AC rotary electric machine 30. The current command calculation unit 41 calculates a d-axis current command value Cid and a q-axis current command value Ciq based on the torque command. The current command calculation unit 41 outputs the d-axis current command value Cid to the d-axis current controller 42. The current command calculation unit 41 outputs the q-axis current command value Ciq to the q-axis current controller 43.

The current amounts iU, iV, and iW are input to the three-phase-to-two-phase current conversion unit 47 from the first current sensor 33a, the second current sensor 33b, and the third current sensor 33c, respectively. The three-phase-to-two-phase current conversion unit 47 converts, based on the magnetic pole position θ from the magnetic pole position detector 31, the current amounts Iu, iV, and iW of three phases into current amounts of two phases, that is, a d-axis current value id and a q-axis current value iq.

The three-phase-to-two-phase current conversion unit 47 outputs the d-axis current value id to the d-axis current controller 42, and outputs the q-axis current value iq to the q-axis current controller 43.

The d-axis current controller 42 calculates a d-axis voltage command value Cvd that is a command value of a DC voltage so that a deviation between the d-axis current command value Cid from the current command calculation unit 41 and the d-axis current value id from the three-phase-to-two-phase current conversion unit 47 is “0”, and outputs the d-axis voltage command value Cvd to the two-phase-to-three-phase voltage conversion unit 44.

The q-axis current controller 43 calculates a q-axis voltage command value Cvq that is a command value of a DC voltage so that a deviation between the q-axis current command value Ciq from the current command calculation unit 41 and the q-axis current value iq from the three-phase-to-two-phase current conversion unit 47 is “0”, and outputs the q-axis voltage command value Cvq to the two-phase-to-three-phase voltage conversion unit 44.

The two-phase-to-three-phase voltage conversion unit 44 converts, based on the magnetic pole position θ from the magnetic pole position detector 31, the d-axis voltage command value Cvd and the q-axis voltage command value Cvq that are command values of DC voltages of two phases into voltage command values Cvu, Cvv, and Cvw that are command values of AC voltages of three phases, and outputs the voltage command values Cvu, Cvv, and Cvw to the PWM circuit 45.

The PWM circuit 45 outputs a plurality of switch control signals to the gate driver 46. Each of the switch control signals is a signal for controlling a switching element corresponding to the switch control signal, out of the plurality of switching elements included in the inverter 20.

The gate driver 46 causes, based on each of the switching control signals from the PWM circuit 45, the corresponding switching element to execute the switching operation.

### <Overheat Protection Control Device>

The overheat protection control device 70 includes, as function blocks, a DC power calculation unit 71, a first determination output value setting unit 72, a heat amount calculation unit 75, a first determination heat amount-equivalent value setting unit 76, a second determination heat amount-equivalent value setting unit 77, a DC power command unit 78, a maximum current adjustment unit 81, an allowable torque calculation unit 82, and a torque command calculation unit 83.

The overheat protection control device 70 executes overheat protection of a monitoring target part. That is, the overheat protection control device 70 protects the monitoring target part so as to keep the monitoring target part from an overheated state. The monitoring target part is the conductor 14 or a part around the conductor 14. The overheat protection control device 70 outputs the torque command to the current command calculation unit 41.

The DC power calculation unit 71 calculates an electric power in the inverter 20. Specifically, the DC power calculation unit 71 calculates a DC power supplied to the inverter 20, based on the DC voltage Vdc and the DC current Idc. The DC power has a value obtained by performing absolute value processing on a product of the DC voltage Vdc and the DC current Idc. The value of the DC power, having been processed by the absolute value processing, is applicable to both of power running operation and regenerative operation.

The DC power calculation unit 71 outputs the DC power to the heat amount calculation unit 75, the first determination heat amount-equivalent value setting unit 76, the second determination heat amount-equivalent value setting unit 77, and the maximum current adjustment unit 81.

The DC power may be calculated by arithmetic processing other than the arithmetic processing in which absolute value processing is performed on the product of the DC voltage and the DC current. For example, in the power running operation of the AC rotary electric machine 30, the DC power may be calculated by arithmetic processing in which absolute value processing is performed on a value obtained by dividing a product of the torque and the rpm by a motor efficiency and by an inverter efficiency, or may be calculated from a value obtained by dividing the AC power by the inverter efficiency. In the regenerative operation of the AC rotary electric machine 30, the DC power may be calculated by arithmetic processing in which absolute value processing is performed on a product of the torque, the rpm, the motor efficiency, and the inverter efficiency, or may be calculated from a product of the AC power and the inverter efficiency.

The value of the DC power is applicable to both of the power running operation and the regenerative operation also when those calculation methods are used.

The first determination output value setting unit 72 stores a first determination output value. The first determination output value is a threshold value of the DC power which is set in advance. The first determination output value is set to a minimum value of the DC power that causes the temperature of the monitoring target part to exceed a limit temperature and consequently leads to breakage of the monitoring target part when the DC power having that value is output in succession. The limit temperature is a temperature unique to the monitoring target part. The first determination output value from the first determination output value setting unit 72 is input to the heat amount calculation unit 75.

The DC power calculated by the DC power calculation unit 71, the first determination output value from the first determination output value setting unit 72, and the water temperature detected by the water temperature detector 80 are input to the heat amount calculation unit 75. The heat amount calculation unit 75 includes a product-of-current-squared-and-time calculation unit 73 and a subtraction value acquisition unit 74.

The product-of-current-squared-and-time calculation unit 73 calculates a product-of-current-squared-and-time value. The product-of-current-squared-and-time value is a value obtained by multiplying the square of the DC current Idc by time. The subtraction value acquisition unit 74 obtains a subtraction value. The subtraction value is a value set based on the DC power and the water temperature detected by the water temperature detector 80.

The heat amount calculation unit 75 compares the DC power calculated by the DC power calculation unit 71 and the first determination output value from the first determination output value setting unit 72, and calculates a heat amount-equivalent value based on a result of the comparison.

When the value of the DC power is equal to or larger than the first determination output value, the heat amount calculation unit 75 calculates a heat amount-equivalent value of this time by adding the product-of-current-squared-and-time value calculated by the product-of-current-squared-and-time calculation unit 73 to a heat amount-equivalent value of the last time.

When the value of the DC power is smaller than the first determination output value, the heat amount calculation unit 75 calculates a heat amount-equivalent value of this time by subtracting the subtraction value obtained by the subtraction value acquisition unit 74 from a heat amount-equivalent value of the last time.

The heat amount calculation unit 75 outputs the heat amount-equivalent value to the DC power command unit 78. A minimum value of the heat amount-equivalent value calculated by the heat amount calculation unit 75 is 0 in this case. When the heat amount-equivalent value drops to a negative value, the product of the current squared and time to be added until a heat amount-equivalent value equivalent to an overheat protection temperature is reached increases, and the temperature consequently becomes equal to or higher than the set overheat protection temperature.

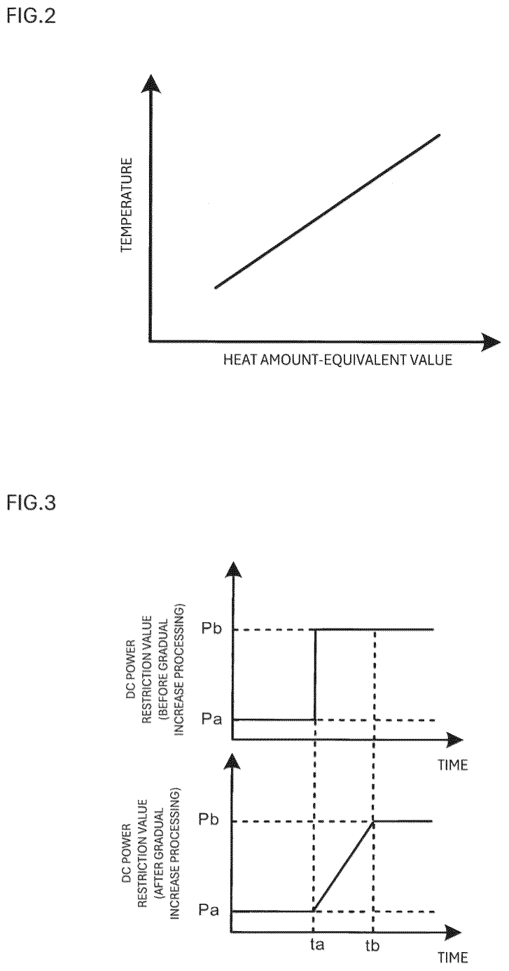

FIG. 2 is a graph for showing an example of a relationship between the heat amount-equivalent value and the temperature. The heat amount-equivalent value, that is, a heat generation amount, is expressed as a value obtained by multiplying the square of the current by time. When the heat generation amount is large, the temperature of the monitoring target part is naturally high.

Referring back to FIG. 1, the first determination heat amount-equivalent value setting unit 76 sets a first determination heat amount-equivalent value. The first determination heat amount-equivalent value is a heat amount-equivalent value that varies depending on one or more factors out of the water temperature, the DC power, the rpm, and the AC current. The first determination heat amount-equivalent value is also a heat amount-equivalent value at which the temperature of the monitoring target part is equivalent to the overheat protection temperature. The first determination heat amount-equivalent value from the first determination heat amount-equivalent value setting unit 76 is input to the DC power command unit 78. A method of setting the first determination heat amount-equivalent value is described later.

The second determination heat amount-equivalent value setting unit 77 sets a second determination heat amount-equivalent value. The second determination heat amount-equivalent value is a heat amount-equivalent value that varies depending on one or more factors out of the water temperature, the DC power, the rpm, and the AC current. The second determination heat amount-equivalent value is also a heat amount-equivalent value at which the temperature of the monitoring target part is equal to or lower than a temperature equivalent to the overheat protection temperature. The second determination heat amount-equivalent value from the second determination heat amount-equivalent value setting unit 77 is input to the DC power command unit 78. The second determination heat amount-equivalent value is a value smaller than the first determination heat amount-equivalent value. A method of setting the second determination heat amount-equivalent value is described later.

The DC power command unit 78 controls the electric power of the inverter 20 based on the heat amount-equivalent value calculated by the heat amount calculation unit 75. To describe in more detail, the DC power command unit 78 compares the heat amount-equivalent value calculated by the heat amount calculation unit 75 to the first determination heat amount-equivalent value and to the second determination heat amount-equivalent value, and sets a DC power restriction value based on results of the comparison.

When the heat amount-equivalent value calculated by the heat amount calculation unit 75 becomes equal to or larger than the first determination heat amount-equivalent value, the DC power command unit 78 lowers the DC power restriction value. This restricts the DC power in the inverter 20 to the DC power restriction value, and accordingly protects the monitoring target part from an overheated state.

When the heat amount-equivalent value calculated by the heat amount calculation unit 75 becomes equal to or smaller than the second determination heat amount-equivalent value, the DC power command unit 78 increases the DC power restriction value. This lifts the restriction on the DC power in the inverter 20, thus allowing the DC power restriction value to become equal to or more than the DC power. Protection of the monitoring target part is consequently canceled.

When switching the DC power restriction value, the DC power command unit 78 gradually decreases or gradually increases the DC power restriction value at a slope set in advance.

FIG. 3 is a graph for showing an example of a state in which the DC power restriction value gradually increases when the DC power restriction value is switched by the DC power command unit 78 of FIG. 1. An axis of abscissa of FIG. 3 represents time. An axis of ordinate of FIG. 3 represents the DC power restriction value.

For example, in a case in which the slope at which the DC power restriction value gradually increases is (Pb-Pa)/(tb-ta), when the DC power restriction value is to be switched from Pa to Pb, the DC power restriction value shifts from Pa to Pb over a length of time (tb-ta).

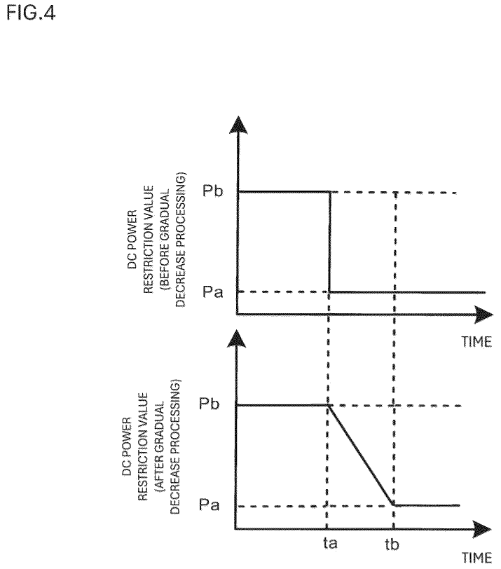

FIG. 4 is a graph for showing an example of a state in which the DC power restriction value gradually decreases when the DC power restriction value is switched by the DC power command unit 78 of FIG. 1. An axis of abscissa of FIG. 4 represents time. An axis of ordinate of FIG. 4 represents the DC power restriction value.

For example, in a case in which the slope at which the DC power restriction value gradually decreases is (Pa-Pb)/(tb-ta), when the DC power restriction value is to be switched from Pb to Pa, the DC power restriction value shifts from Pb to Pa over the length of time (tb-ta).

Referring back to FIG. 1, the maximum current adjustment unit 81 adjusts a maximum current of the AC rotary electric machine 30, and outputs an adjusted maximum current Imax_adj to the allowable torque calculation unit 82.

The maximum current adjustment unit 81 restricts the maximum current of the AC rotary electric machine 30 so that the DC power obtained by the DC power calculation unit 71 does not exceed the DC power restriction value set by the DC power command unit 78. This keeps the temperature of the monitoring target part from exceeding a restricted temperature set in advance, and accordingly prevents breakage of the monitoring target part due to overheating.

A specific configuration and operation of the maximum current adjustment unit 81 are described later. The target of adjustment of a control amount is not required to be an electric current and may be any parameter as long as the temperature can be suppressed.

The allowable torque calculation unit 82 calculates allowable torque Ctrq_alw based on the adjusted maximum current Imax_adj output from the maximum current adjustment unit 81. A specific method of calculating the allowable torque Ctrq_alw is described later.

The torque command calculation unit 83 calculates a torque command value Ctrq so that the torque falls within a range of the allowable torque Ctrq_alw output from the allowable torque calculation unit 82, and outputs the torque command value Ctrq to the current command calculation unit 41.

### <Maximum Current Adjustment Unit>

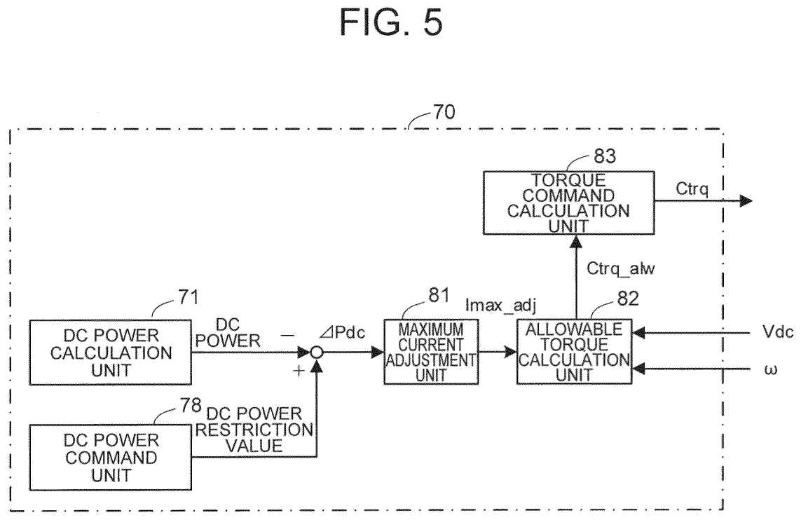

FIG. 5 is a block diagram for illustrating an essential part of the overheat protection control device 70 of FIG. 1. The maximum current adjustment unit 81 adjusts the maximum current Imax based on a power deviation ΔPdc between the DC power and the DC power restriction value set by the DC power command unit 78, and outputs the adjusted maximum current Imax_adj. The adjusted maximum current Imax_adj is a maximum allowable current value.

The maximum current adjustment unit 81 also adjusts the value of the maximum current Imax so that the DC power restriction value set by the DC power command unit 78 does not exceed a preset temperature of the monitoring target part. This keeps the temperature of the monitoring target part from exceeding the restricted temperature set in advance, and accordingly prevents breakage of the monitoring target part due to overheating.

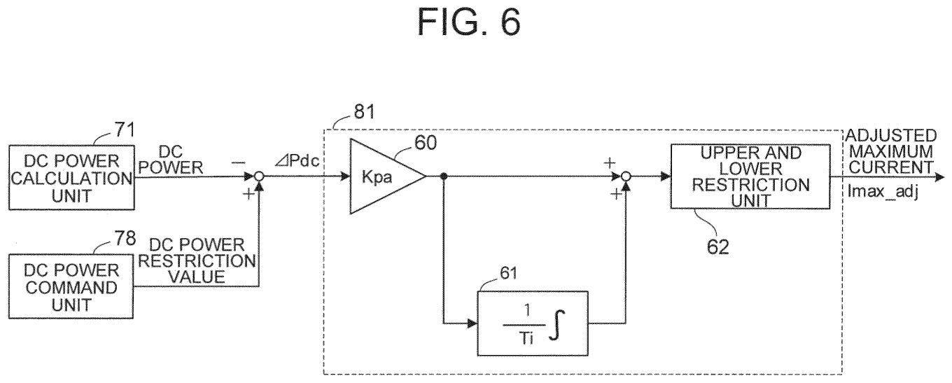

FIG. 6 is a block diagram for illustrating an example of a detailed configuration of the maximum current adjustment unit 81 of FIG. 5. In the example of FIG. 6, the maximum current adjustment unit 81 includes a proportional adjuster 60, an integral adjuster 61, and an upper and lower restriction unit 62.

The power deviation ΔPdc between the DC power and the DC power restriction value set by the DC power command unit 78 is input to the maximum current adjustment unit 81. The power deviation ΔPdc is a value obtained by subtracting the DC power from the DC power restriction value set by the DC power command unit 78. Accordingly, the DC power deviation ΔPdc is a negative value when the value of the DC power exceeds the DC power restriction value. In this case, the value of the DC power deviation ΔPdc decreases as the value of the DC power increases.

The proportional adjuster 60 outputs a value obtained by multiplying the input deviation by a proportional gain Kpa. In this example, the proportional gain Kpa in the proportional adjuster 60 is a positive value.

The integral adjuster 61 integrates the output of the proportional adjuster 60, with an initial value being an “upper limit value of the maximum current Imax.” The “upper limit value of the maximum current Imax” is a value obtained as a result of calculation in which the “phase current absolute value” expressed by Equation (2) given above is calculated with use of a d-axis current that is maximum in design and a q-axis current that is maximum in design.

That is, an electric current having the “phase current absolute value” that is larger than the “upper limit value of the maximum current Imax” is never intentionally caused to flow under any condition. Meanwhile, the maximum current Imax has a shifting value and is adjusted between “zero” and the “upper limit value of the maximum current Imax.”

When the value of the DC power grows larger than the DC power restriction value set by the DC power command unit 78, the output of the proportional adjuster 60 becomes a negative value and, accordingly, the output of the proportional adjuster 60 turns to a negative value. Specifically, the DC power deviation ΔPdc has a negative value when the value of the DC power is larger than the DC power restriction value.

The proportional adjuster 60 outputs a value obtained by multiplying the deviation by the proportional gain Kpa. The output of the proportional adjuster 60 is accordingly a negative value when the DC power deviation ΔPdc is a negative value. In this case, the integral adjuster 61 integrates the negative value, with the result that output of the integral adjuster 61 gradually decreases from the initial value.

When the DC power is equal to or less than the DC power restriction value set by the DC power command unit 78, on the other hand, the output of the proportional adjuster 60 is a positive value. As the output of the proportional adjuster 60 turns to a positive value, the output of the integral adjuster 61 increases.

In this manner, a proportional adjustment and an integral adjustment are performed on the DC power deviation ΔPdc by the proportional adjuster 60 and the integral adjuster 61. The output of the proportional adjuster 60 and the output of the integral adjuster 61 are input to an adder. The adder outputs a value obtained by adding the output of the proportional adjuster 60 and the output of the integral adjuster 61, as a post-proportional adjustment and post-integral adjustment output value.

The upper and lower restriction unit 62 places an upper restriction and a lower restriction on the output value from the adder. In the upper and lower restriction unit 62, an upper limit value is the “upper limit value of the maximum current Imax” and a lower limit value is “0”.

The upper and lower restriction unit 62 calculates the adjusted maximum current Imax_adj by placing the upper restriction and the lower restriction with use of the upper limit value and the lower limit value.

Specifically, in a case in which the output value from the adder is equal to or smaller than the upper limit value and equal to or larger than the lower limit value, the upper and lower restriction unit 62 outputs, as the adjusted maximum current Imax_adj, the output value from the adder without modification.

In a case in which the output value from the adder is larger than the upper limit value, on the other hand, the upper and lower restriction unit 62 outputs the upper limit value as the adjusted maximum current Imax_adj. In a case in which the output value from the adder is smaller than the lower limit value, the upper and lower restriction unit 62 outputs the lower limit value as the adjusted maximum current Imax_adj.

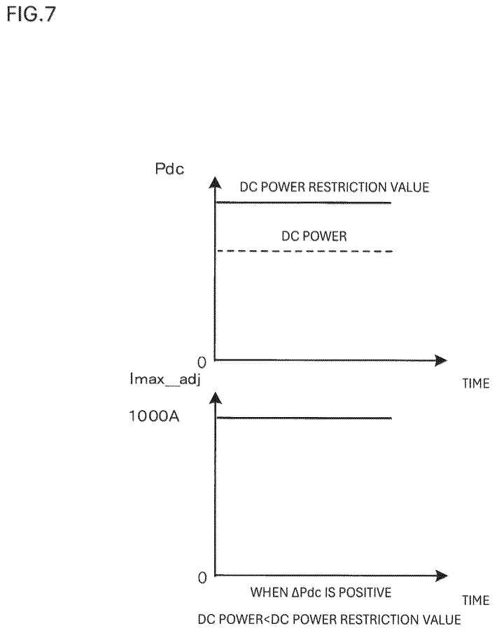

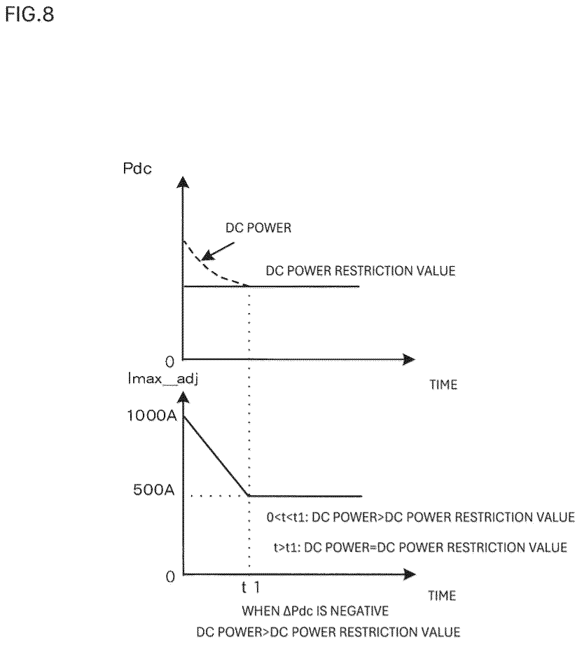

FIG. 7 is a graph for showing a first example of a relationship between input and output in the maximum current adjustment unit 81 of FIG. 6, and is an illustration of a case in which the DC power deviation ΔPdc is positive. FIG. 8 is a graph for showing a second example of the relationship between input and output in the maximum current adjustment unit 81 of FIG. 6, and is an illustration of a case in which the DC power deviation ΔPdc is negative.

An initial value of the maximum current Imax_adj which is the output is the upper limit value of the maximum current Imax, for example, 1,000 A.

The case shown in FIG. 7 in which the DC power deviation ΔPdc is positive is considered first. Because the value of the DC power is smaller than the DC power restriction value, the output of the proportional adjuster 60 is positive, the output of the integral adjuster 61 is positive as well, and the output of the upper and lower restriction unit 62 increases. The adjusted maximum current Imax_adj thus keeps being added to, until 1,000 A which is the upper limit value is output from the upper and lower restriction unit 62 as the adjusted maximum current Imax_adj.

Next, the case shown in FIG. 8 in which the DC power deviation ΔPdc is negative is considered. Because the value of the DC power is larger than the DC power restriction value, the output of the proportional adjuster 60 is negative, the output of the integral adjuster 61 is negative as well, and the output of the upper and lower restriction unit 62 decreases. The adjusted maximum current Imax_adj thus keeps being subtracted from, and the output of the upper and lower restriction unit 62 is a value obtained by subtraction from the upper limit value 1,000 A.

Assuming that the electric current at which the value of the DC power becomes equal to the DC power restriction value is 500 A, the value input to the upper and lower restriction unit 62 decreases until the maximum current Imax becomes 500 A. When the electric current settles at 500 A, balance between the value of the DC power and the DC power restriction value is maintained, and the DC power deviation ΔPdc consequently becomes 0. The adjusted maximum current Imax_adj thus keeps receiving feedback control so as to become the electric current of the DC power restriction value, and 500 A is output from the upper and lower restriction unit 62 as the adjusted maximum current Imax_adj.

In the example of FIG. 6, the upper limit value is set to the “upper limit value of the maximum current Imax,” and the adjusted maximum current Imax_adj accordingly does not exceed the “upper limit value of the maximum current Imax.” The adjusted maximum current Imax_adj is also kept from becoming a negative value because the lower limit value is set to “0”.

The configuration of the maximum current adjustment unit 81 is not limited to the example of FIG. 6, and the maximum current Imax that energizes the AC rotary electric machine 30 may be adjusted by other methods.

### <Allowable Torque Calculation Unit>

Next, the allowable torque calculation unit 82 of FIG. 5 is described. The allowable torque calculation unit 82 first calculates a maximum voltage Vmax with use of the DC voltage Vdc detected by the voltage detector 11 and a maximum modulation factor MFmax set in advance, by the following arithmetic equation.

$$V max = 1 / sqrt ( 2 ) \times sqrt ( 3 ) / 2 \times V dc \times MF max$$

The allowable torque calculation unit 82 next calculates a maximum interlinkage magnetic flux FLmax with use of the maximum voltage Vmax and the electrical angular velocity ω detected by the electrical angular velocity calculation unit 50, by the following arithmetic equation.

FLmax=Vmax÷ω

The allowable torque calculation unit 82 also obtains an upper limit value Ctrq_alw_upper and a lower limit value Ctrq_alw_lower of the allowable torque Ctrq_alw, based on the maximum interlinkage magnetic flux FLmax and the adjusted maximum current Imax_adj input from the maximum current adjustment unit 81.

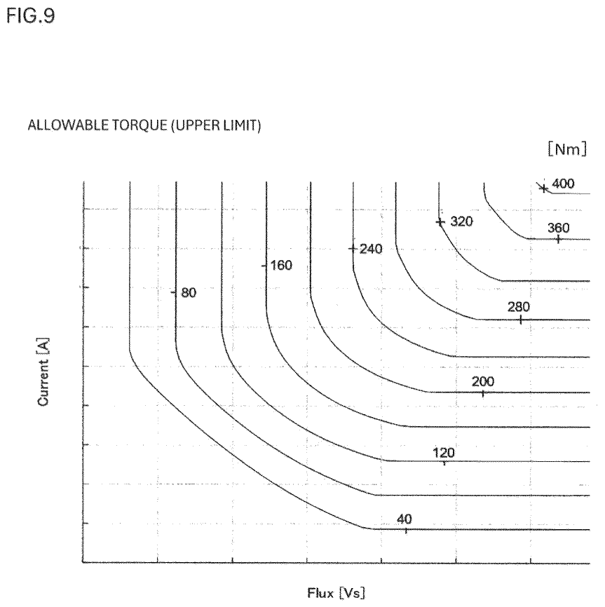

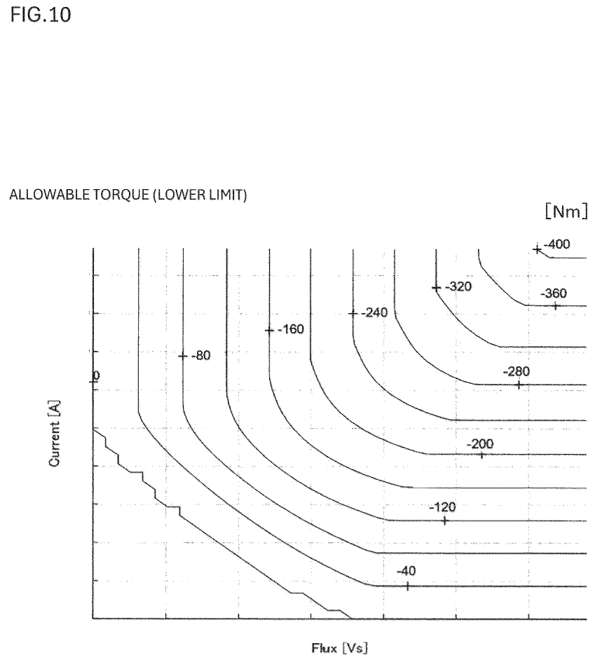

FIG. 9 is a table for showing an example of a method of obtaining the upper limit value Ctrq_alw_upper of the allowable torque in the allowable torque calculation unit 82 of FIG. 5. FIG. 10 is a table for showing an example of a method of obtaining the lower limit value Ctrq_alw_lower of the allowable torque in the allowable torque calculation unit 82 of FIG. 5.

In FIG. 9 and FIG. 10, an axis of abscissa represents the maximum interlinkage magnetic flux FLmax and an axis of ordinate represents the adjusted maximum current Imax_adj. The allowable torque calculation unit 82 uses, for example, the table shown in FIG. 9 and the table shown in FIG. 10 to obtain the upper limit value Ctrq_alw_upper and the lower limit value Ctrq_alw_lower of the allowable torque, respectively.

The upper limit value Ctrq_alw_upper and the lower limit value Ctrq_alw_lower of the allowable torque which are obtained by the allowable torque calculation unit 82 are input to the torque command calculation unit 83, and a torque command value Ctrq is set by the torque command calculation unit 83.

### <Torque Command Calculation Unit>

The torque command calculation unit 83 sets an adjusted value of the torque command value Ctrq as described in the following items (1) to (3).
(1) A case in which “the torque command value>the upper limit value of the allowable torque” is satisfied:

→Ctrq=Ctrq_alw_upper
(2) A case in which “the upper limit value of the allowable torque the torque command value≥the lower limit value of the allowable torque” is satisfied:

→Ctrq=Ctrq
(3) A case in which “the torque command value<the lower limit value of the allowable torque” is satisfied:

→Ctrq=Ctrq_alw_lower

In this manner, the adjusted torque command value Ctrq is set by the torque command calculation unit 83. The adjusted torque command value Ctrq is then handed over from the torque command calculation unit 83 to the current command calculation unit 41 of the inverter control device 40.

### <Operation of Overheat Protection Control Device>

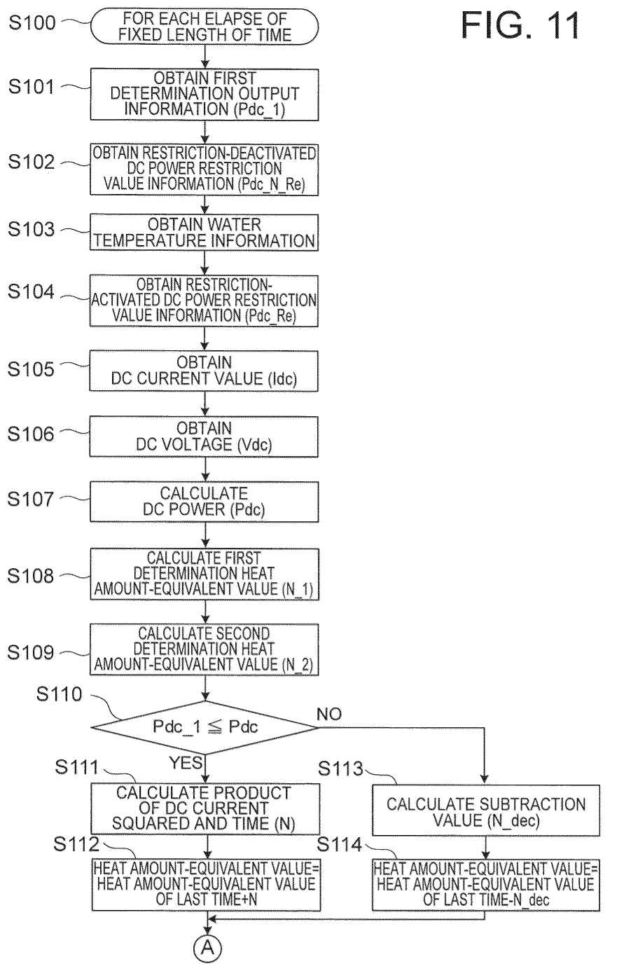

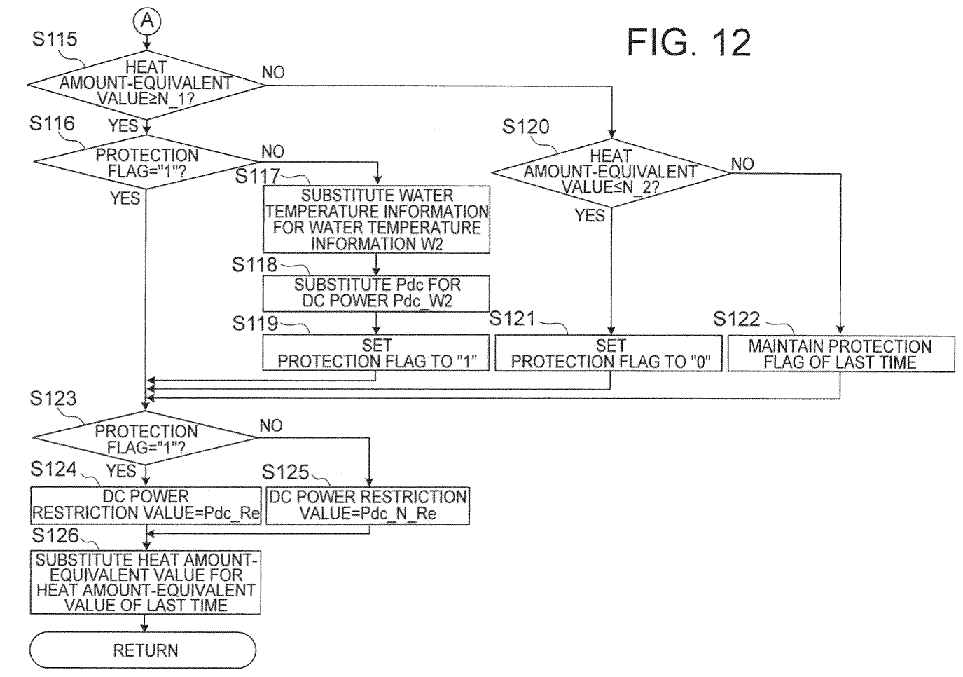

Next, a flow of operation in the overheat protection control device 70 is described with reference to FIG. 11 and FIG. 12. FIG. 11 is a flow chart for illustrating a first half of the operation of the overheat protection control device 70 of FIG. 1. FIG. 12 is a flow chart for illustrating a second half of the operation of the overheat protection control device 70 of FIG. 1.

The operation of FIG. 11 is called in Step S100 each time a fixed length of time elapses. When the operation of FIG. 11 is started, the overheat protection control device 70 obtains, in Step S101, a first determination output value Pdc_1 set in the first determination output value setting unit 72. Subsequently, in Step S102, the overheat protection control device 70 obtains a restriction-deactivated DC power restriction value Pdc_N_Re. The restriction-deactivated DC power restriction value Pdc_N_Re is a maximum DC power allowable in the inverter 20. The overheat protection control device 70 further obtains water temperature information from the water temperature detector 80 in Step S103.

The overheat protection control device 70 then obtains, in Step S104, a restriction-activated DC power restriction value Pdc_Re based on the obtained water temperature information. Subsequently, in Step S105, the overheat protection control device 70 obtains the DC current Idc. The overheat protection control device 70 further obtains the DC voltage Vdc in Step S106.

The overheat protection control device 70 then calculates a DC power Pdc in Step S107. In Step S108, the overheat protection control device 70 calculates a first determination heat amount-equivalent value N_1, based on the obtained water temperature information and the calculated DC power Pdc.

Subsequently, in Step S109, the overheat protection control device 70 calculates a second determination heat amount-equivalent value N_2, based on a water temperature W2 and a DC power Pdc_W2. The water temperature W2 is obtained in Step S117, and the DC power Pdc_W2 is obtained in Step S118. A method of obtaining the water temperature W2 and the DC power Pdc_W2 which are used to calculate the second determination heat amount-equivalent value N_2 is described later.

Next, in Step S110, the overheat protection control device 70 compares the DC power Pdc obtained through the processing step of Step S107 and the first determination output value Pdc_1 obtained through the processing step of Step S101.

In a case in which the DC power Pdc is equal to or more than the first determination output value Pdc_1, the overheat protection control device 70 calculates a product N of current squared and time in Step S111. The product N of current squared and time is a value obtained by multiplying the square of the DC current Idc obtained in the processing step of Step S105 by time.

After calculating the product N of current squared and time, in Step S112, the overheat protection control device 70 adds the product N of current squared and time calculated in the processing step of Step S111 to a heat amount-equivalent value of the last time, and the process proceeds to Step S115 of FIG. 12.

In a case in which the DC power Pdc is less than the first determination output value Pdc_1, on the other hand, the overheat protection control device 70 calculates a subtraction value N_dec in Step S113, based on the water temperature obtained in the processing step of Step S103 and the DC power Pdc calculated in the processing step of Step S107.

After calculating the subtraction value N_dec, in Step S114, the overheat protection control device 70 subtracts the subtraction value N_dec calculated in the processing step of Step S113 from the heat amount-equivalent value of the last time, and the process proceeds to Step S115 of FIG. 12.

Next, in Step S115 of FIG. 12, the overheat protection control device 70 compares the heat amount-equivalent value calculated in the processing step of Step S112, or the processing step of Step S114, and the first determination heat amount-equivalent value N_1 obtained in the processing step of Step S108.

In a case in which the heat amount-equivalent value is equal to or larger than the first determination heat amount-equivalent value N_1, the overheat protection control device 70 determines whether a protection flag is “1” in Step S116. When the overheat protection control device 70 determines that the protection flag is “1”, the process proceeds to Step S123.

When the protection flag is “0”, the overheat protection control device 70 substitutes the water temperature information for the water temperature information W2 in Step S117. The overheat protection control device 70 also substitutes Pdc for the DC power Pdc_W2 in Step S118. In Step S119, the overheat protection control device 70 sets the protection flag to “1”, and the process then proceeds to Step S123.

In a case in which the heat amount-equivalent value is smaller than the first determination heat amount-equivalent value N_1, on the other hand, the overheat protection control device 70 compares, in Step S120, the heat amount-equivalent value and the second determination heat amount-equivalent value N_2 obtained in the processing step of Step S109.

In a case in which the heat amount-equivalent value is equal to or smaller than the second determination heat amount-equivalent value N_2, the overheat protection control device 70 sets the protection flag to “0” in Step S121, and the process proceeds to Step S123.

In a case in which the heat amount-equivalent value is larger than the second determination heat amount-equivalent value N_2, on the other hand, the overheat protection control device 70 maintains the protection flag of the last time in Step S122, and the process proceeds to Step S123.

Next, in Step S123, the overheat protection control device 70 determines whether the protection flag is “1”.

When the protection flag is “1”, the overheat protection control device 70 sets, in Step S124, the DC power restriction value to the restriction-activated DC power restriction value Pdc_Re obtained in the processing step of Step S104, and restricts the output power.

When the protection flag is “0”, the overheat protection control device 70 sets, in Step S125, the DC power restriction value to the restriction-deactivated DC power restriction value Pdc_N_Re obtained in the processing step of Step S102, and lifts the output restriction.

The overheat protection control device 70 then substitutes the heat amount-equivalent value for the heat amount-equivalent value of the last time in Step S126, to thereby update heat amount-equivalent value information with the latest value.

Through the operation described above, the inverter 20 equipped with a function of protecting a monitoring target part from overheating is controlled. The processing of FIG. 11 and FIG. 12 is repeatedly executed each time a fixed length of time Δt elapses. The fixed length of time Δt may be, for example, an arithmetic processing cycle of a micro-computer. When the arithmetic processing cycle Δt is shorter, the heat amount-equivalent value is updated at a higher frequency, and the temperature can accordingly be estimated with high precision.

A data acquisition method in the overheat protection control device 70 is described next.

### <Product N of Current Squared and Time>

The product N of current squared and time corresponds to a heat generation amount, and a value proportional to the square of the electric current Idc is calculated for each time Δt for detecting the electric current. As in a commonly known understanding of Joule heat, the heat generation amount naturally increases when the electric current increases and when the electric current flows for a longer duration of time. The heat generation amount decreases when the electric current decreases and when the electric current flows for a shorter duration of time.

### <First Determination Heat Amount-Equivalent Value N_1>

The first determination heat amount-equivalent value N_1 corresponds to a temperature at which protection from overheating is activated, and is a value determined depending on one or more factors out of the water temperature, the DC power, the rpm, and the AC current.

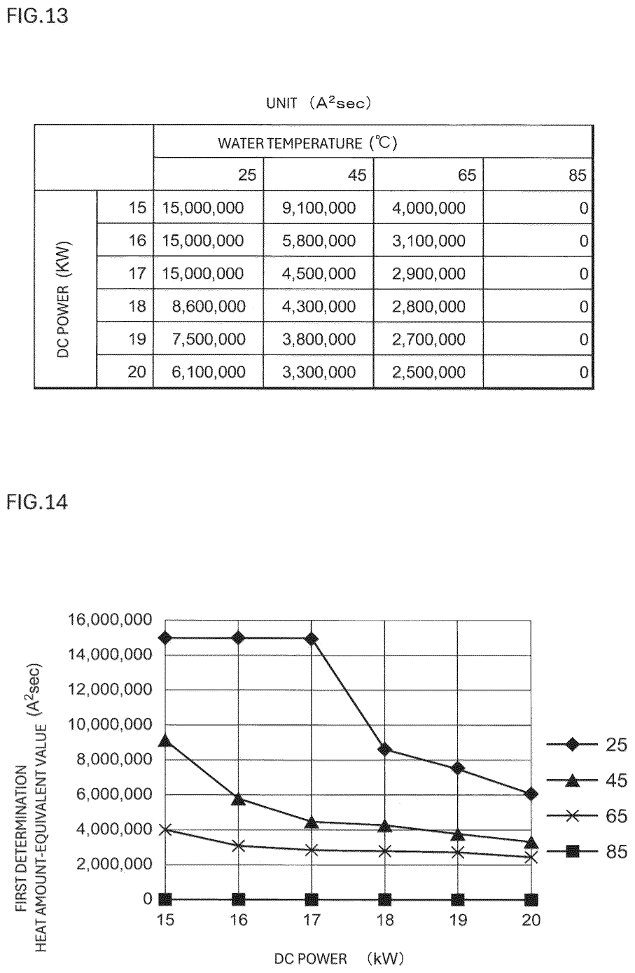

FIG. 13 is a table for showing an example of a relationship between the water temperature, the DC power, and the first determination heat amount-equivalent value N_1. FIG. 14 is a graph for showing the relationship between the water temperature, the DC power, and the first determination heat amount-equivalent value N_1 which corresponds to FIG. 13.

Values shown in FIG. 13 and values shown in FIG. 14 are values determined based on data obtained in advance, and vary from one product to another product, from one usage environment to another usage environment, or the like. That is, the first determination heat amount-equivalent value N_1 is not limited to the values shown in FIG. 13 and FIG. 14.

A case in which the water temperature changes is considered first. For example, when the water temperature is 25° C. and the DC power is 15 kW, the first determination heat amount-equivalent value N_1 is 15,000,000. When the water temperature is 65° C. and the DC power is 15 kW, the first determination heat amount-equivalent value N_1 is 4,000,000. When the water temperature is 85° C. and the DC power is 15 kW, the first determination heat amount-equivalent value N_1 is 0.

In this manner, the first determination heat amount-equivalent value N_1 is set smaller when the water temperature is higher. When the heat generation amount is the same, the temperature of the monitoring target part rises with an increase in water temperature. Accordingly, by setting the first determination heat amount-equivalent value N_1 small at a high water temperature, an overheat protection temperature can be adjusted so as to have a constant value. In the case in which the first determination heat amount-equivalent value N_1 is 0, an output power equal to or more than the first determination output value is restricted.

When the water temperature is other than a preset temperature, the first determination heat amount-equivalent value N_1 is calculated by linear interpolation from water temperatures of two points set in advance. For example, when the water temperature is 75° C. and the DC power is 15 kW, the first determination heat amount-equivalent value N_1 is calculated to be 12,000,000 by linear interpolation of the value at a water temperature of 65° C. and a DC power of 15 kW, and the value at a water temperature of 85° C. and a DC power of 15 kW.

A case in which the DC power changes is considered next. For example, when the water temperature is 25° C. and the DC power is 15 kW, the first determination heat amount-equivalent value N_1 is 15,000,000. When the water temperature is 25° C. and the output power is 19 kW, the first determination heat amount-equivalent value N_1 is 7,500,000. When the water temperature is 25° C. and the output power is 20 kW, the first determination heat amount-equivalent value N_1 is 6,100,000.

In this manner, the first determination heat amount-equivalent value N_1 is set smaller when the DC power is higher. When the water temperature is the same, the temperature of the monitoring target part rises with an increase in DC power. Accordingly, by setting the first determination heat amount-equivalent value N_1 small at a high DC power, the overheat protection temperature can be adjusted so as to have a constant value.

When the value of the DC power is other than a preset value, the first determination heat amount-equivalent value N_1 is calculated by linear interpolation from values of the DC power at two points set in advance. For example, when the water temperature is 25° C. and the DC power is 19.5 kW, the first determination heat amount-equivalent value N_1 is calculated to be 6,800,000 by linear interpolation of the value at a water temperature of 25° C. and a DC power of 19 kW, and the value at a water temperature of 25° C. and a DC power of 20 kW.

### <Second Determination Heat Amount-Equivalent Value N_2>

The second determination heat amount-equivalent value N_2 corresponds to a temperature at which protection from overheating is canceled, and is a value determined depending on one or more factors out of the water temperature, the DC power, the rpm, and the AC current.

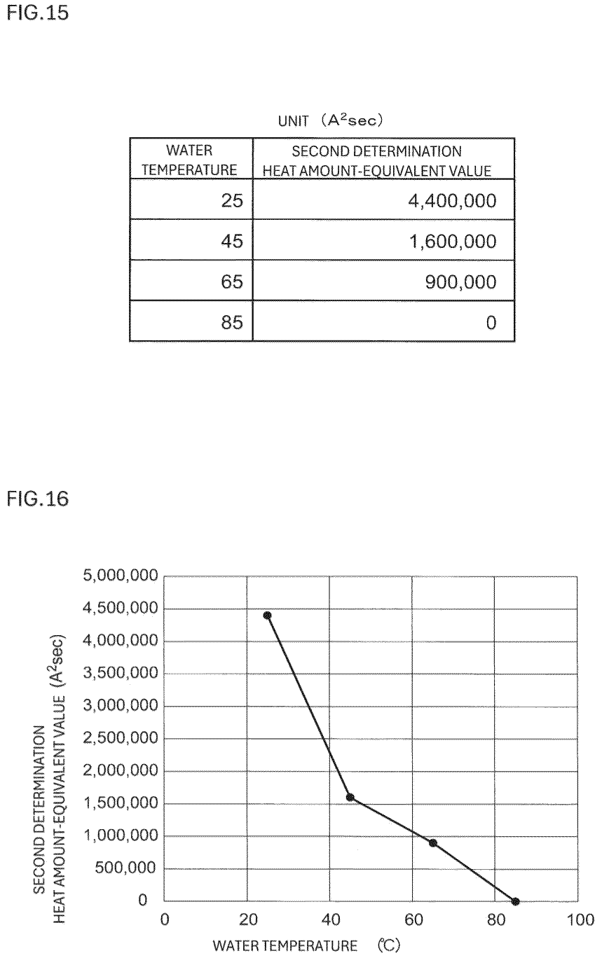

FIG. 15 is a table for showing an example of a relationship between the water temperature and the second determination heat amount-equivalent value N_2. FIG. 16 is a graph for showing the relationship between the water temperature and the second determination heat amount-equivalent value N_2 which corresponds to FIG. 15.

Values shown in FIG. 15 and values shown in FIG. 16 are values determined based on data obtained in advance, and vary from one product to another product, from one usage environment to another usage environment, or the like. That is, the second determination heat amount-equivalent value N_2 is not limited to the values shown in FIG. 15 and FIG. 16.

When the water temperature is 25° C., the second determination heat amount-equivalent value N_2 is 4,400,000. When the water temperature is 65° C., the second determination heat amount-equivalent value N_2 is 900,000. When the water temperature is 85° C., the second determination heat amount-equivalent value N_2 is 0.

In this manner, the second determination heat amount-equivalent value N_2 is set smaller when the water temperature is higher. When the heat generation amount is the same, the temperature of the monitoring target part rises with an increase in water temperature. Accordingly, by setting the second determination heat amount-equivalent value N_2 small at a high water temperature, a temperature at which overheat protection is canceled can be adjusted so as to have a constant value. Depending on utilization situations, the temperature at which overheat protection is canceled is adjustable.

When the water temperature is other than a preset temperature, the second determination heat amount-equivalent value N_2 is calculated by linear interpolation from water temperatures of two points set in advance. For example, when the water temperature is 75° C., the second determination heat amount-equivalent value N_2 is calculated to be 450,000 by linear interpolation of the value at a water temperature of 65° C. and the value at a water temperature of 85° C.

### <Subtraction Value N_dec>

The subtraction value N_dec corresponds to a magnitude of a drop in temperature, and is a value determined depending on the water temperature and the DC power.

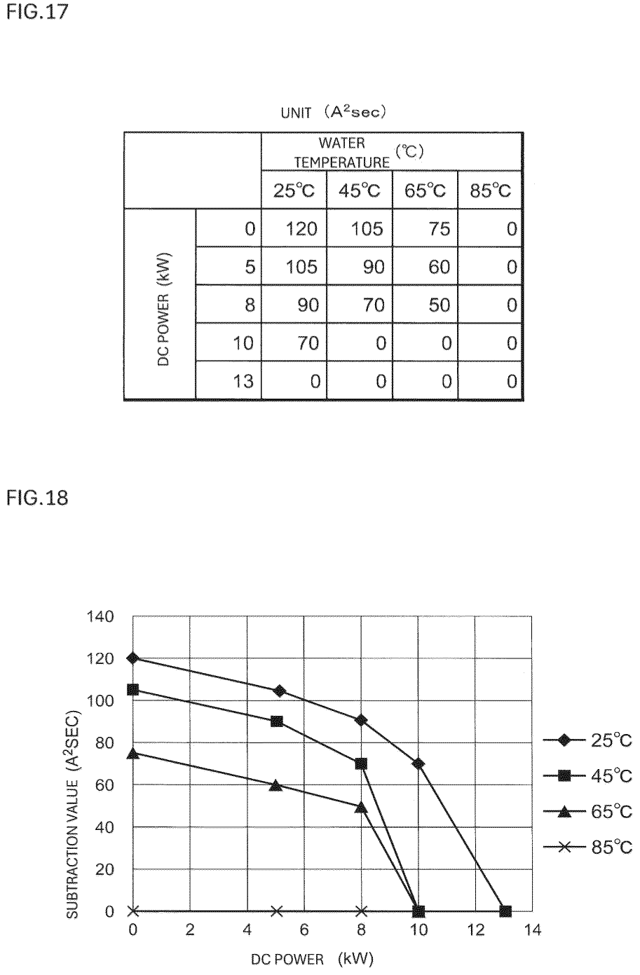

FIG. 17 is a table for showing an example of a relationship between the water temperature, the DC power, and the subtraction value N_dec. FIG. 18 is a graph for showing the relationship between the water temperature, the DC power, and the subtraction value N_dec which corresponds to FIG. 17.

Values shown in FIG. 17 and values shown in FIG. 18 are values determined based on data obtained in advance, and vary from one product to another product, from one usage environment to another usage environment, or the like. That is, the subtraction value N_dec is not limited to the values shown in FIG. 17 and FIG. 18.

The subtraction value N_dec shown in FIG. 17 and FIG. 18 is a value assumed to be processed at an interval of, for example, 10 ms. In this case, when an actual processing cycle is 1 ms, values that are 1/10 times the values shown in FIG. 17 and FIG. 18 are used as the subtraction value N_dec.

When data shown in FIG. 17 and FIG. 18 is obtained, a time required for a drop from a first temperature to a second temperature which is lower than the first temperature is measured, and the first temperature and the second temperature are converted into heat amount-equivalent values, to thereby calculate the subtraction value N_dec per unit time.

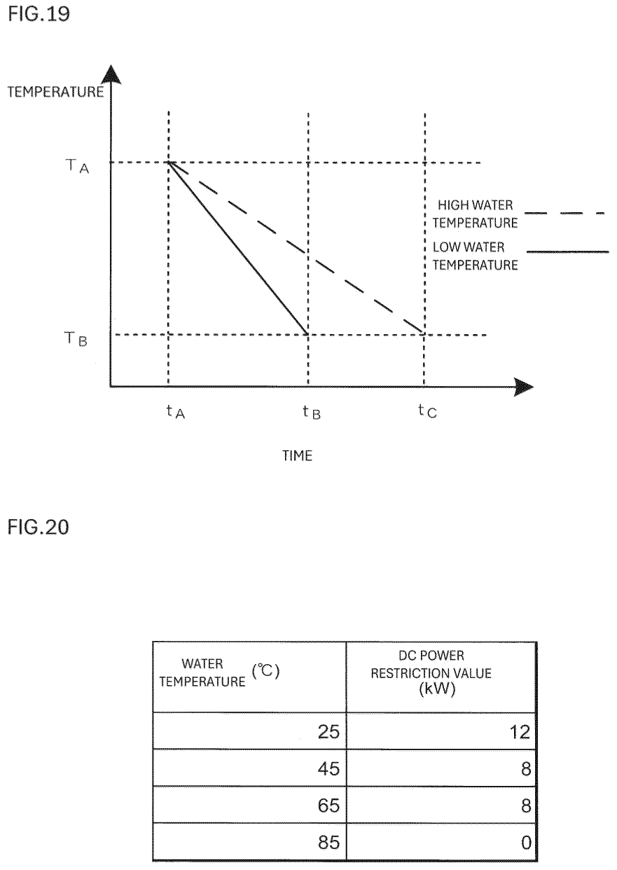

FIG. 19 is a graph for showing results of measuring changes with time of a temperature of a conductor at a time when the water temperature is high and a time when the water temperature is low.

When the water temperature is low, a time required for the temperature of the conductor to change from a first temperature TA to a second temperature TB is tB-tA. When the water temperature is high, on the other hand, the temperature drops slowly, and the time required for the change from the first temperature TA to the second temperature TB is accordingly tC-tA which is longer than when the water temperature is low.

The subtraction value N_dec per unit time is calculable by converting the temperature into the heat amount-equivalent value based on the relationship shown in FIG. 2. The calculated subtraction value N_dec is smaller when the water temperature is high than when the water temperature is low.

A case in which the water temperature changes is considered first. For example, when the water temperature is 25° C. and the DC power is 0 kW, the subtraction value N_dec is 120. When the water temperature is 65° C. and the DC power is 0 kW, the subtraction value N_dec is 75. When the water temperature is 85° C. or higher and the DC power is 0 kW, the subtraction value N_dec is 0.

The subtraction value N_dec is thus smaller when the water temperature is higher. When the water temperature increases with the heat generation amount remaining the same, a rate at which the temperature of the monitoring target part drops decreases with the increase in water temperature. Accordingly, temperature shifts corresponding to changes in time series can be simulated by setting the subtraction value N_dec small at a high water temperature. Conversely, when the water temperature decreases with the heat generation amount remaining the same, the rate at which the temperature of the monitoring target part drops increases with the decrease in water temperature, and temperature shifts corresponding to changes in time series can accordingly be simulated by setting the subtraction value N_dec large at a low water temperature.

When the water temperature is other than a preset temperature, the subtraction value N_dec is calculated by linear interpolation from water temperatures of two points. For example, when the water temperature is 75° C. and the DC power is 0 kW, the subtraction value N_dec is calculated to be 37.5 by linear interpolation of the value at a water temperature of 65° C. and a DC power of 0 kW, and the value at a water temperature of 85° C. and a DC power of 0 kW.

A case in which the DC power changes is considered next. For example, when the water temperature is 25° C. and the DC power is 0 kW, the subtraction value N_dec is 120. When the water temperature is 25° C. and the DC power is 10 kW, the subtraction value N_dec is 70. When the water temperature is 25° C. and the DC power is 13 kW, the subtraction value N_dec is 0.

In this manner, the subtraction value N_dec is set smaller when the DC power is higher. When the DC power is higher, the heat generation amount is larger and the rate at which the temperature of the monitoring target part drops decreases. Accordingly, temperature shifts corresponding to changes in time series can be simulated by setting the subtraction value N_dec small. Conversely, when the DC power is lower, the heat generation amount is smaller, the rate at which the temperature of the monitoring target part drops increases and, accordingly, temperature shifts corresponding to changes in time series can be simulated by setting the subtraction value N_dec large.

When the value of the DC power is other than a preset value, the subtraction value N_dec is calculated by linear interpolation from values of the DC power at two points set in advance. For example, when the water temperature is 25° C. and the DC power is 11.5 kW, the subtraction value N_dec is calculated to be 35 by linear interpolation of the value at a water temperature of 25° C. and a DC power of 10 kW, and the value at a water temperature of 25° C. and a DC power of 13 kW.

### <Restriction-Activated DC Power Restriction Value Pdc_Re>

The restriction-activated DC power restriction value Pdc_Re corresponds to maximum output, and is a value determined depending on the water temperature.

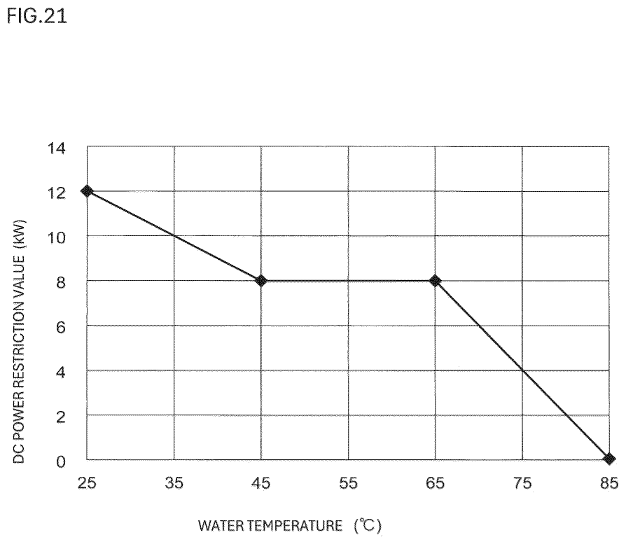

FIG. 20 is a table for showing an example of a relationship between the water temperature and the restriction-activated DC power restriction value Pdc_Re. FIG. 21 is a graph for showing the relationship between the water temperature and the restriction-activated DC power restriction value Pdc_Re which corresponds to FIG. 20.

Values shown in FIG. 20 and values shown in FIG. 21 are values determined based on data obtained in advance, and vary from one product to another product, from one usage environment to another usage environment, or the like. That is, the restriction-activated DC power restriction value Pdc_Re is not limited to the values shown in FIG. 20 and FIG. 21.

For example, when the water temperature is 25° C., the restriction-activated DC power restriction value Pdc_Re is 12 kW. When the water temperature is 65° C., the restriction-activated DC power restriction value Pdc_Re is 8 kW. When the water temperature is 85° C., the restriction-activated DC power restriction value Pdc_Re is 0 kW.

In this manner, the restriction-activated DC power restriction value is set smaller when the water temperature is higher. When the heat generation amount is the same, the temperature of the monitoring target part rises with an increase in water temperature. Accordingly, by setting the restriction-activated DC power restriction value Pdc_Re small at a high water temperature, the monitoring target part can be brought to a temperature within a range of the overheat protection temperature. In the case in which the restriction-activated DC power restriction value Pdc_Re is 0 kW, the heat generation amount cannot be increased any more, and the output power is accordingly restricted to 0 kW.

When the water temperature is other than a preset temperature, the restriction-activated DC power restriction value Pdc_Re is calculated by linear interpolation from water temperatures of two points set in advance. For example, when the water temperature is 75° C., the restriction-activated DC power restriction value Pdc_Re is calculated to be 4 kW by linear interpolation of the value at a water temperature of 65° C. and the value at a water temperature of 85° C.

### <Timing Chart>

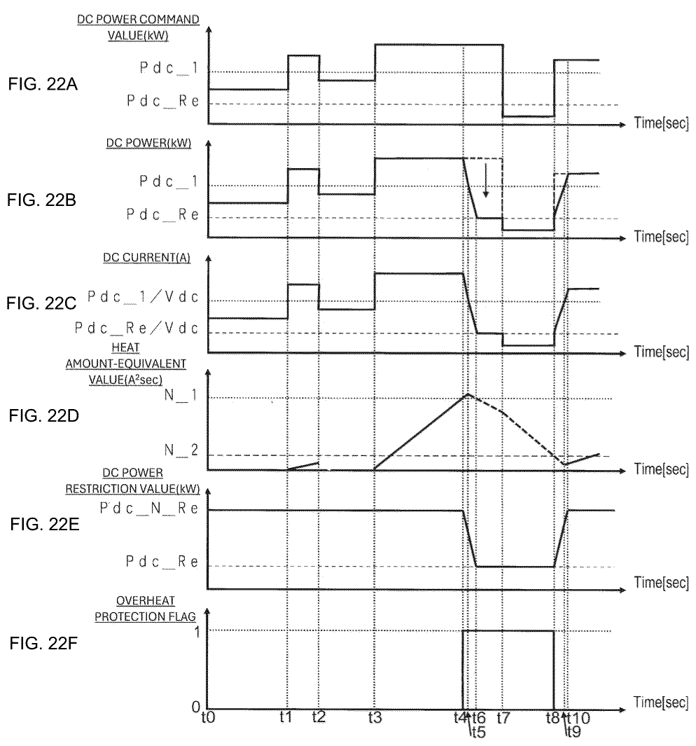

FIG. 22 are timing charts for illustrating overheat protection operation in the first embodiment. The overheat protection operation and overheat protection canceling operation are described below with reference to FIG. 22.

In FIG. 22A, an axis of abscissa represents time and an axis of ordinate represents a DC power command value. In FIG. 22A, the first determination output value Pdc_1 and the restriction-activated DC power Pdc_Re are shown side by side.

In FIG. 22B, an axis of abscissa represents time and an axis of ordinate represents a DC power. In FIG. 22B, the first determination output value Pdc_1 and the restriction-activated DC power Pdc_Re are shown side by side.

In FIG. 22C, an axis of abscissa represents time and an axis of ordinate represents the DC current. In FIG. 22C, an electric current Pdc_1/Vdc in a case of the first determination output value Pdc_1 and an electric current Pdc_Re/Vdc in a case of the restriction-activated DC power Pdc_Re at a DC voltage of Vdc are shown side by side.

In FIG. 22D, an axis of abscissa represents time and an axis of ordinate represents the heat amount-equivalent value. In FIG. 22D, the heat amount-equivalent value, the first determination heat amount-equivalent value N_1, and the second determination heat amount-equivalent value N_2 are shown side by side.

In FIG. 22E, an axis of abscissa represents time and an axis of ordinate represents the DC power restriction value. In FIG. 22E, the restriction-deactivated DC power Pdc_N_Re and the restriction-activated DC power Pdc_Re are shown side by side.

In FIG. 22F, an axis of abscissa represents time and an axis of ordinate represents the overheat protection flag.

For example, in a case in which an initial heat amount-equivalent value is 0, the DC power is equal to or less than the first determination output value Pdc_1 in a section from t0 to t1. Accordingly, there is no addition to the heat amount-equivalent value, and the heat amount-equivalent value at a time point t1 is 0.

In a section from t1 to t2, the DC power is equal to or more than the first determination output value Pdc_1 and, accordingly, an addition is made to the heat amount-equivalent value. An added value in this case is N=Idc²ₜ₂₋ₜ₁×(t2−t1), and the heat amount-equivalent value at a time point t2 is Idc²ₜ₂₋ₜ₁×(t2−t1).

In a section from t2 to t3, the DC power is equal to or less than the first determination output value Pdc_1 and, accordingly, a value is subtracted from the heat amount-equivalent value. The subtraction value in this case is determined to be N_dect₂₋ₜ₃ by referring to FIG. 17. The heat amount-equivalent value at a time point t3 is Idc²ₜ₂₋ₜ₁×(t2−t1)−N_decₜ₂₋ₜ₃×(t3−t2).

In a section from t3 to t4, the DC power is equal to or more than the first determination output value Pdc_1 and, accordingly, an addition is made to the heat amount-equivalent value. An added value in this case is N=Idc²ₜ₄₋ₜ₃×(t4−t3). The heat amount-equivalent value at a time point t4 is Idc²ₜ2-t1×(t2−t1)−N_decₜ₂₋ₜ₃×(t3−t2)+Idc²ₜ4-t3×(t4−t3).

The heat amount-equivalent value at the time point t4 reaches the first determination heat amount-equivalent value N_1 because a condition for adding to the heat amount-equivalent value has been kept satisfied, and the overheat protection flag consequently switches from “₀” to “1”. With the overheat protection flag switched to “1”, the DC power command unit 78 suppresses the DC power by switching the DC power restriction value from the restriction-deactivated DC power Pdc_N_Re to the restriction-activated DC power Pdc_Re.

The restriction-activated DC power Pdc_Re in this case is set by referring to FIG. 20. However, the DC power restriction value gradually decreases from Pdc_N_Re to Pdc_Re over a fixed length of time as shown in FIG. 4. The DC power command value and the DC power thus gradually decrease along with the DC power restriction value.

However, even after the output power is restricted, an addition is made to the heat amount-equivalent value in a section from t4 to t5 in which the DC power is equal to or more than the first determination output value Pdc_1. The DC power at this point of time has changed and, in a case in which the DC voltage Vdc is constant, Idcₜ₅₋ₜ₄ changes.

For a simplified description, a value that is an average of the DC current in the section from t4 to t5 is given as Idcₜ₅₋ₜ₄, and an added value in this case is N=Idc²ₜ5-t4×(t5−t4). The heat amount-equivalent value at a time point t5 is Idc²ₜ2-t1×(t2−t1)−N_decₜ₂₋ₜ₃×(t3−t2)+Idc²ₜ4-t3×(t4−t3)+Idc²ₜ5-t4×(t5−t4).

In a section from t5 to t6, the output power is restricted, and the DC power continues to gradually decrease along with the DC power restriction value to reach the first determination output value Pdc_1 or lower. A value is accordingly subtracted from the heat amount-equivalent value. The subtraction value in this case is determined to be N_decₜ₅₋ₜ₆ by referring to FIG. 17.

In a section from t6 to t7, the output power is restricted to the restriction-activated DC power Pdc_Re and is equal to or less than the first determination output value Pdc_1. A value is accordingly subtracted from the heat amount-equivalent value. The subtraction value in this case is determined to be N_decₜ₆₋ₜ₇ by referring to FIG. 17. The heat amount-equivalent value at a time point t7 is Idc²ₜ2-t1×(t2−t1)−N_decₜ₂₋ₜ₃×(t3−t2)+Idc²ₜ4-t3×(t4−t3)+Idc²ₜ5-t4×(t5−t 4)−N_decₜ₅₋ₜ₆×(t6−t5)−N_decₜ₆₋ₜ₇×(t7−t6).

In a section from t7 to t8, the DC power command value takes a value smaller than Pdc_Re, and the value of the DC power is smaller than Pdc_Re as well. A value is subtracted from the heat amount-equivalent value because the DC power is equal to or less than the first determination output value Pdc_1. The subtraction value in this case is determined to be N_decₜ₇₋ₜ₈ by referring to FIG. 17. In the section from t7 to t8, a subtraction coefficient of the heat amount-equivalent value is larger than in the section from t6 to t7.

The heat amount-equivalent value at a time point t8 is Idc²ₜ2-t1×(t2−t1)−N_decₜ₂₋ₜ₃×(t3−t2)+Idc²ₜ4-t3×(t4−t3)+Idc²ₜ5-t4×(t5−t4)−N_decₜ₅₋ₜ₆×(t6-t5)−N_decₜ₆₋ₜ₇×(t7−t6)−N_decₜ₇₋ₜ₈×(t8−t7).

The heat amount-equivalent value at the time point t8 reaches the second determination heat amount-equivalent value N_2 because a condition for subtracting from the heat amount-equivalent value has been kept satisfied, and the overheat protection flag consequently switches from “1” to “0”. With the overheat protection flag switched to “0”, the DC power command unit 78 cancels overheat protection by switching the DC power restriction value from the restriction-activated DC power Pdc_Re to the restriction-deactivated DC power Pdc_N_Re.

The DC power restriction value in this case turns to a restriction-deactivated DC power Pdc_N_Reₜ₈. The switching of the DC power restriction value causes the DC power restriction value to gradually increase over a fixed length of time as shown in FIG. 3, until Pdc_N_Reₜ₈ is reached. The DC power command value and the DC power thus gradually increase along with the DC power restriction value.

In a section from t8 to t9, the output power restriction is lifted and the DC power gradually increases along with the DC power restriction value, but a value is subtracted from the heat amount-equivalent value because the DC power is equal to or less than the first determination output value Pdc_1. The subtraction value in this case is determined to be N_decₜ₈₋ₜ₉ by referring to FIG. 17.

The heat amount-equivalent value at a time point t9 is Idc²ₜ2-t1×(t2−t1)−N_decₜ₂₋ₜ₃×(t3−t2)+Idc²ₜ4-t3×(t4−t3)+Idc²ₜ5-t4×(t5−t4)−N_dect₅₋ₜ₆×(t6−t5)−N_dect₆₋ₜ₇×(t7−t6)−N_decₜ₇₋ₜ₈×(t8−t7)−N_decₜ₈₋ₜ₉×(t9−t8).

In a section from t9 to t10, the DC power becomes equal to or more than the first determination output value Pdc_1 again, and an addition is accordingly made to the heat amount-equivalent value. An added value in this case is, when a value that is an average of the DC current in the section from t9 to t10 is given as Idcₜ₁₀₋ₜ₉, N=Idc²ₜ10-t9×(t10−t9).

The heat amount-equivalent value at the time point t9 is Idc²ₜ2-t1×(t2−t1)−N_decₜ₂₋ₜ₃×(t3−t2)+Idc²ₜ4-t3×(t4−t3)+Idc²ₜ5-t4×(t5−t4)−N_decₜ₅₋ₜ₆×(t6−t5)−N_decₜ₆₋ₜ₇×(t7−t6)−N_decₜ₇₋ₜ₈×(t8−t7)−N_decₜ₈₋ₜ₉×(t9−t8)+Idc²ₜ10-t9×(t10−t9).

In the overheat protection control device 70 described above, when the value of the DC power is equal to or larger than the first determination output value Pdc_1, the heat amount calculation unit 75 adds a product of the current squared and time calculated by the product-of-current-squared-and-time calculation unit 73 to the heat amount-equivalent value of the last time. When the value of the DC power is smaller than the first determination output value Pdc_1, the heat amount calculation unit 75 calculates the heat amount-equivalent value of this time by subtracting the subtraction value which is obtained by the subtraction value acquisition unit 74 from the heat amount-equivalent value of the last time.

When the heat amount-equivalent value calculated by the heat amount calculation unit 75 becomes the first determination heat amount-equivalent value N_1 or larger, the DC power command unit 78 restricts the DC power in the inverter 20. When the heat amount-equivalent value calculated by the heat amount calculation unit 75 becomes the second determination heat amount-equivalent value N_2 or smaller, the DC power command unit 78 lifts restriction on the DC power in the inverter 20.

Cessation of the operation of the inverter 20 is accordingly avoidable when overheat protection of the monitoring target part is executed. Excessive protection of the inverter 20 can thus be reduced, with the result that a drop in operation efficiency of the inverter 20 is reduced.

The inverter 20 is provided between the DC power source 10 and the AC rotary electric machine 30. In this case, a situation in which the DC power source 10 cannot be charged during regeneration mode operation of the AC rotary electric machine 30 can be reduced.

For example, in a case in which the AC rotary electric machine 30 is used in an electrified vehicle, such as an electric vehicle or a hybrid vehicle, a situation in which the DC power source 10, that is, a battery cannot be charged during regeneration mode driving is reduced.

In addition, the temperature of the monitoring target part can be estimated in a simpler manner without performing complicate compensation and estimation. The temperature of the monitoring target part can thus be controlled so as to be equal to or lower than a limit temperature with more ease, and malfunction of the monitoring target part is consequently reduced.

The DC power calculation unit 71 uses a detected value or an estimated value of the DC current to calculate the DC power. The heat amount calculation unit 75 calculates the heat amount-equivalent value based on the DC power calculated by the DC power calculation unit 71 and the first determination output value Pdc_1 from the first determination output value setting unit 72. The DC power command unit 78 controls electric power in the inverter 20 based on the heat amount-equivalent value calculated by the heat amount calculation unit 75. With the heat amount-equivalent value thus updated each time, responsiveness is high and a precision of temperature estimation from the heat amount-equivalent value can be improved.

The first determination output value Pdc_1 is set to a minimum value that causes the temperature of the monitoring target part to exceed a limit temperature and consequently leads to breakage of the monitoring target part when the DC power having that value is output in succession. Accordingly, breakage of the monitoring target part is prevented more securely.

The subtraction value N_dec varies depending on one or more factors out of the water temperature and the DC power. The heat amount-equivalent value can accordingly be set to a more appropriate value.

The DC power calculation unit 71 performs absolute value processing when calculating the DC power. The calculated value of the DC power is accordingly applicable to both of the power running operation and the regenerative operation of the AC rotary electric machine 30.

The DC power restriction value is a value that varies depending on the water temperature. When the DC power command unit 78 switches the power restriction value, the DC power command unit 78 gradually decreases or increases the power restriction value at a slop set in advance. A switch between overheat protection and canceling of the overheat protection can thus be executed smoothly.

### Second Embodiment

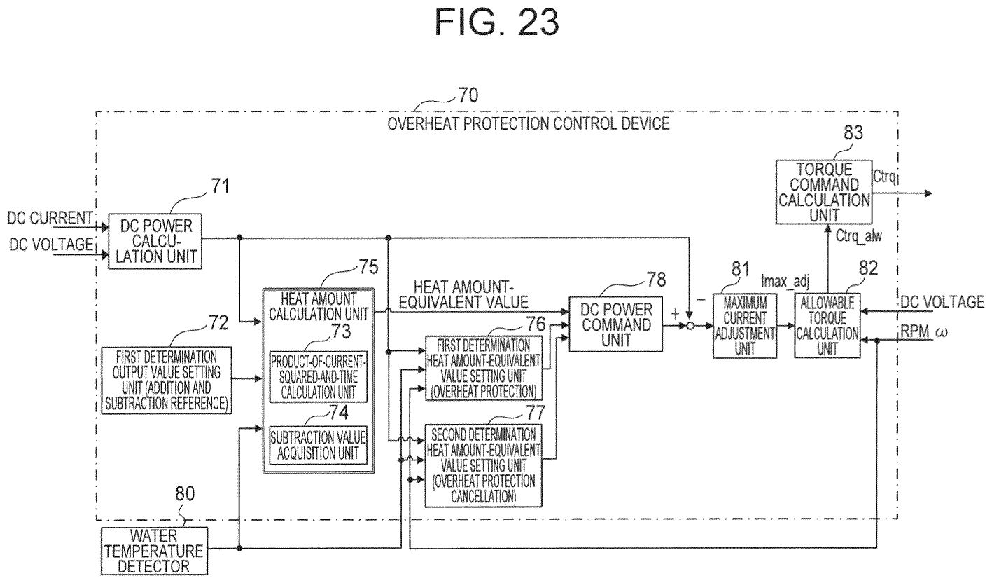

FIG. 23 is a block diagram for illustrating an essential part of the overheat protection control device 70 according to a second embodiment of this disclosure. In the second embodiment, the method of setting the first determination heat amount-equivalent value N_1 by the first determination heat amount-equivalent value setting unit 76 and the method of setting the second determination heat amount-equivalent value N_2 by the second determination heat amount-equivalent value setting unit 77 are changed from the setting methods in the first embodiment. The rest is the same as in the first embodiment and, accordingly, only parts different from those of the first embodiment are described.

In the second embodiment, the first determination heat amount-equivalent value N_1 and the second determination heat amount-equivalent value N_2 vary depending on the rpm of the AC rotary electric machine 30.

As illustrated in FIG. 23, in the second embodiment, the rpm ω is input to each of the first determination heat amount-equivalent value setting unit 76 and the second determination heat amount-equivalent value setting unit 77.

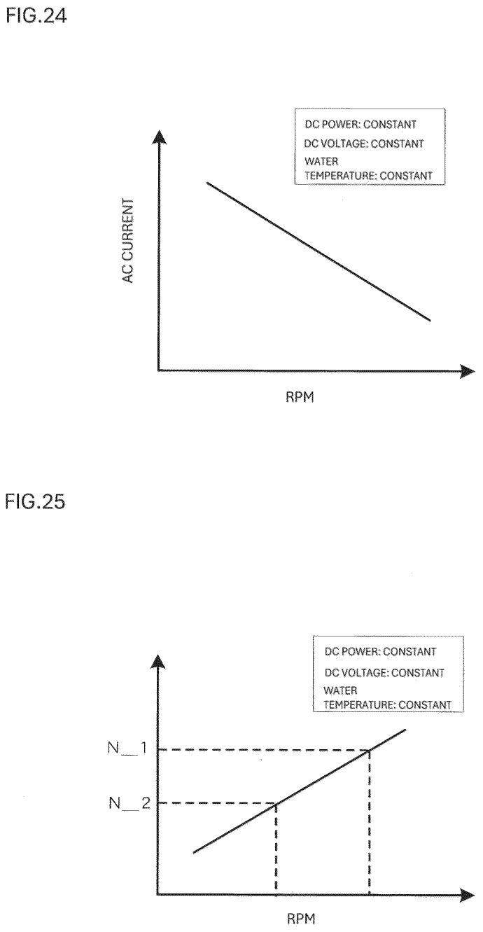

FIG. 24 is a graph for showing an example of a relationship between the rpm and the AC current. FIG. 25 is a graph for showing an example of a relationship of the rpm to the first determination heat amount-equivalent value N_1 and the second determination heat amount-equivalent value N_2.

For example, an increase in rpm in an area that precedes a shoulder of a T-N characteristic causes a decrease in AC current when the DC power, the DC voltage, the DC current, and the water temperature are constant. The decrease in AC current causes the heat generation amount on the AC side to decrease. In a case in which the heat generation amount on the AC side affects the DC side, an increase in rpm causes the temperature on the DC side to drop. Accordingly, because the temperature of the monitoring target part decreases with an increase in rpm when the water temperature and the electric power each remain the same, the overheat protection temperature can be adjusted so as to have a constant value by setting the first determination heat amount-equivalent value N_1 large.

The same applies to the second determination heat amount-equivalent value N_2. The temperature of the monitoring target part decreases with an increase in rpm when the water temperature and the electric power each remain the same, and the temperature at which overheat protection is canceled can accordingly be adjusted so as to have a constant value by setting the second determination heat amount-equivalent value N_2 large. Depending on utilization situations, the temperature at which overheat protection is canceled is adjustable.

### Third Embodiment

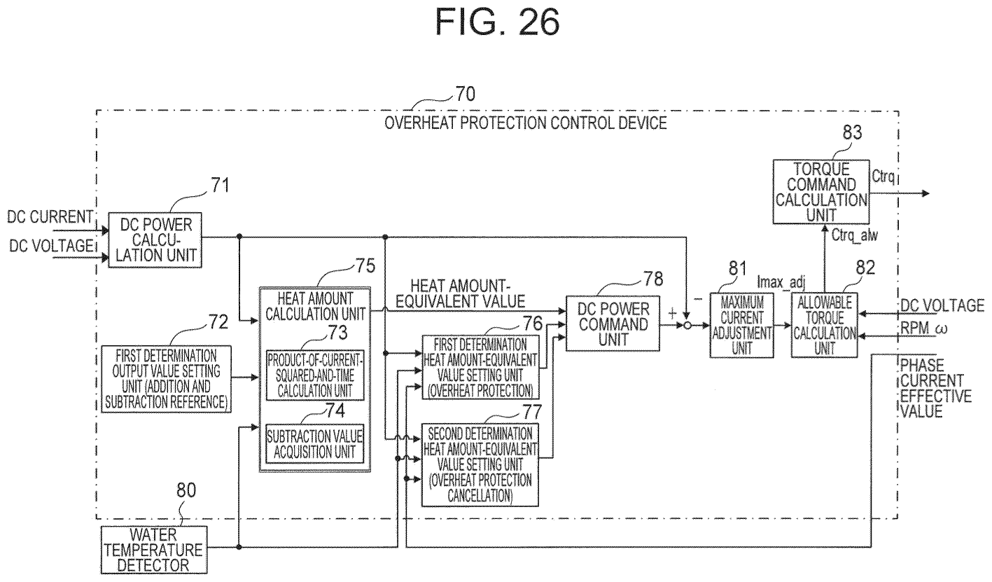

FIG. 26 is a block diagram for illustrating an essential part of the overheat protection control device 70 according to a third embodiment of this disclosure. In the third embodiment, the method of setting the first determination heat amount-equivalent value N_1 by the first determination heat amount-equivalent value setting unit 76 and the method of setting the second determination heat amount-equivalent value N_2 by the second determination heat amount-equivalent value setting unit 77 are changed from the setting methods in the first embodiment. The rest is the same as in the first embodiment and, accordingly, only parts different from those of the first embodiment are described.

In the third embodiment, a case in which the first determination heat amount-equivalent value N_1 and the second determination heat amount-equivalent value N_2 vary depending on the AC current is described.

As illustrated in FIG. 26, in the third embodiment, the AC current, that is, a phase current effective value is input to each of the first determination heat amount-equivalent value setting unit 76 and the second determination heat amount-equivalent value setting unit 77 in the first embodiment.

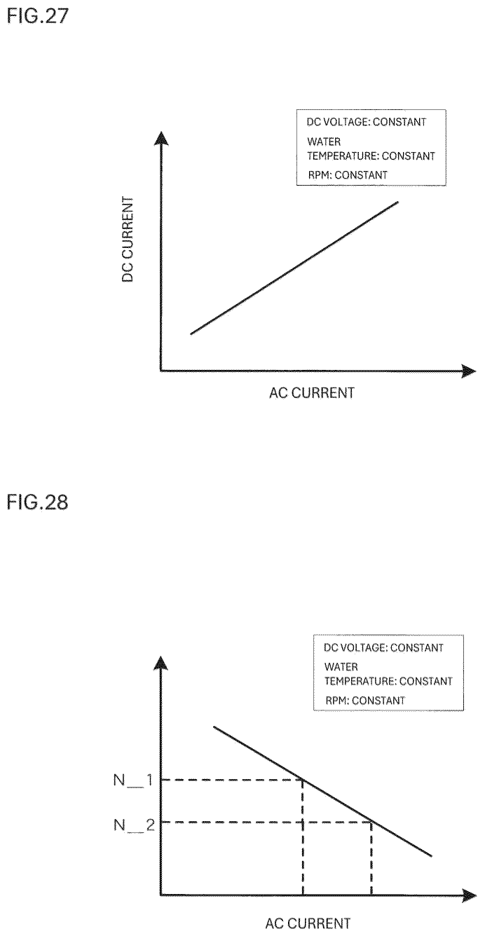

FIG. 27 is a graph for showing an example of a relationship between the AC current and the DC current. FIG. 28 is a graph for showing an example of a relationship of the AC current to the first determination heat amount-equivalent value N_1 and the second determination heat amount-equivalent value N_2.

When the DC voltage, the water temperature, and the rpm are constant, the DC current and the heat generation amount increase with an increase in AC current. Accordingly, because the temperature of the monitoring target part increases with an increase in AC current when the water temperature and the rpm each remain the same, the overheat protection temperature can be adjusted so as to have a constant value by setting the first determination heat amount-equivalent value N_1 small.

The same applies to the second determination heat amount-equivalent value N_2. The temperature of the monitoring target part increases with an increase in AC current when the water temperature and the rpm each remain the same, and the temperature at which overheat protection is canceled can accordingly be adjusted so as to have a constant value by setting the second determination heat amount-equivalent value N_2 small. Depending on utilization situations, the temperature at which overheat protection is canceled is adjustable.

As described above, the first determination heat amount-equivalent value N_1 is a value that varies depending on one or more factors out of the water temperature, the DC power, the rpm of the AC rotary electric machine 30, and the AC current. Overheat protection can accordingly be executed at more appropriate timing.

The second determination heat amount-equivalent value N_2 is a value that varies depending on one or more factors out of the water temperature, the DC power, the rpm of the AC rotary electric machine 30, and the AC current. Overheat protection can accordingly be canceled at more appropriate timing.

The second determination heat amount-equivalent value N_2 is calculated based on one or more factors out of the water temperature, the DC power, the rpm, and the AC current that are observed at a time when the heat amount-equivalent value reaches the first determination heat amount-equivalent value N_1 and overheat protection is executed. The overheat protection can thus be canceled at appropriate timing.

The monitoring target part in the first embodiment to the third embodiment is a part on the DC power source 10 side, that is, the DC side, in the inverter 20. However, the monitoring target part may be a part on the AC side.

The functions of the inverter control device 40 and the overheat protection control device 70 of the first embodiment to the third embodiment are implemented by a processing circuit. FIG. 29 is a configuration diagram for illustrating a first example of the processing circuit that implements the functions of the inverter control device 40 and the functions of the overheat protection control device 70 of the first embodiment to the third embodiment. A processing circuit 100 of the first example is dedicated hardware.

The processing circuit 100 corresponds to, for example, a single circuit, a complex circuit, a programmed processor, a processor for a parallel program, an application specific integrated circuit (ASIC), a field programmable gate array (FPGA), or a combination thereof. The respective functions of the inverter control device 40 and the overheat protection control device 70 may be implemented by individual processing circuits 100, or the functions may be collectively implemented by the processing circuit 100.

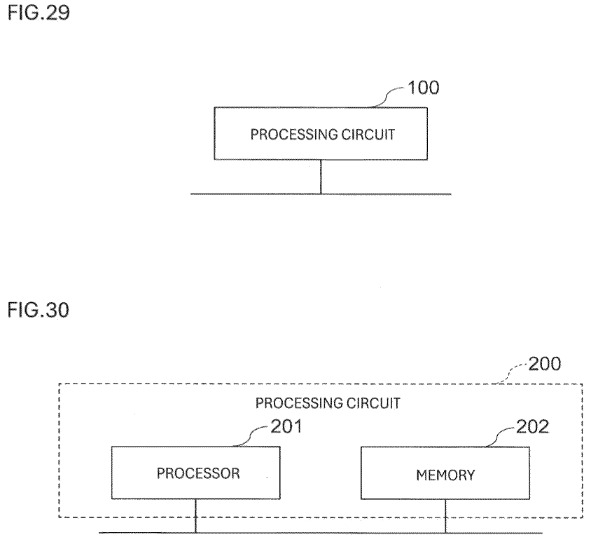

FIG. 30 is a configuration diagram for illustrating a second example of the processing circuit that implements the functions of the inverter control device 40 and the functions of the overheat protection control device 70 of the first embodiment to the third embodiment. A processing circuit 200 of the second example includes a processor 201 and a memory 202.

In the processing circuit 200, the respective functions of the inverter control device 40 and the overheat protection control device 70 are implemented by software, firmware, or a combination of software and firmware. The software and the firmware are described as programs to be stored in the memory 202. The processor 201 reads out and executes the programs stored in the memory 202, to thereby implement the respective functions.

The programs stored in the memory 202 can also be regarded as programs for causing a computer to execute the procedure or method of each of the components described above. In this case, the memory 202 corresponds to, for example, a nonvolatile or volatile semiconductor memory, such as a random access memory (RAM), a read only memory (ROM), a flash memory, an erasable programmable read only memory (EPROM), or an electronically erasable and programmable read only memory (EEPROM). For example, a magnetic disk, a flexible disk, an optical disc, a compact disc, a MiniDisc, and a DVD also correspond to the memory 202.

The function of each of the components described above may be implemented partially by dedicated hardware, and partially by software or firmware.

In this way, the processing circuit can implement the function of each of the components described above by hardware, software, firmware, or a combination thereof.

### REFERENCE SIGNS LIST

10 DC power source, 14 conductor, 20 inverter (power converter), 30 AC rotary electric machine, 70 overheat protection control device, 71 DC power calculation unit, 72 first determination output value setting unit, 75 heat amount calculation unit, 76 first determination heat amount-equivalent value setting unit, 77 second determination heat amount-equivalent value setting unit, 78 DC power command unit

1. An overheat protection control device for a power converter, comprising:
a power calculation unit configured to calculate an electric power in the power converter;
a heat amount calculation unit configured to calculate a heat amount-equivalent value, based on the electric power calculated by the power calculation unit and a first determination output value which is a threshold value of the electric power; and
a power command unit configured to control the electric power in the power converter, based on the heat amount-equivalent value calculated by the heat amount calculation unit,
wherein the heat amount calculation unit is configured to:
add, when the electric power is equal to or more than the first determination output value, to the heat amount-equivalent value of a last time, a value of a product of a current squared and time which is a value obtained by multiplying a square of an electric current flowing in a conductor by the time, the conductor being connected to the power converter; and
subtract, when the electric power is less than the first determination output value, a subtraction value from the heat amount-equivalent value of the last time, and
wherein the power command unit is configured to:
restrict the electric power in the power converter when the heat amount-equivalent value calculated by the heat amount calculation unit becomes a first determination heat amount-equivalent value or larger; and
lift the restriction on the electric power in the power converter when the heat amount-equivalent value calculated by the heat amount calculation unit becomes a second determination heat amount-equivalent value or smaller, the second determination heat amount-equivalent value being smaller than the first determination heat amount-equivalent value.

2. The overheat protection control device for a power converter according to claim 1, wherein the power calculation unit is configured to calculate the electric power with use of a detected value or an estimated value of the electric current.

3. The overheat protection control device for a power converter according to claim 1, wherein the first determination output value is set to a minimum value of the electric power that causes a temperature of a monitoring target part to exceed a limit temperature and consequently leads to breakage of the monitoring target part when the electric power having the minimum value is output in succession, the monitoring target part being the conductor or a part around the conductor.

4. The overheat protection control device for a power converter according to claim 1, wherein the subtraction value is a value that varies depending on one or more factors out of a water temperature of cooling water of the power converter, and the electric power calculated by the power calculation unit.

5. The overheat protection control device for a power converter according to claim 1,
wherein the power converter is an inverter provided between a DC power source and an AC rotary electric machine, and
wherein the power calculation unit is configured to calculate the electric power by:
arithmetic processing in which absolute value processing is performed on a product of a voltage applied to the conductor and the electric current;
arithmetic processing in which absolute value processing is performed on a product of torque of the AC rotary electric machine, the rpm of the AC rotary electric machine, a motor efficiency of the AC rotary electric machine, and an inverter efficiency;
arithmetic processing for obtaining a product of an AC power and the inverter efficiency;
arithmetic processing in which absolute value processing is performed on a value that is obtained by dividing a product of the torque of the AC rotary electric machine and the rpm of the AC rotary electric machine, by the motor efficiency of the AC rotary electric machine and by the inverter efficiency; or
arithmetic processing in which the AC power is divided by the inverter efficiency.

6. The overheat protection control device for a power converter according to claim 1,
wherein the power converter is an inverter provided between a DC power source and an AC rotary electric machine, and
wherein the first determination heat amount-equivalent value is a value that varies depending on one or more factors out of a water temperature of cooling water of the power converter, the electric power calculated by the power calculation unit, the rpm of the AC rotary electric machine, and an AC current.

7. The overheat protection control device for a power converter according to claim 1,
wherein the power converter is an inverter provided between a DC power source and an AC rotary electric machine, and
wherein the second determination heat amount-equivalent value is a value that varies depending on one or more factors out of a water temperature of cooling water of the power converter, the electric power calculated by the power calculation unit, the rpm of the AC rotary electric machine, and an AC current.

8. The overheat protection control device for a power converter according to claim 7, wherein the second determination heat amount-equivalent value is calculated based on one or more factors out of the water temperature, the electric power, the rpm, and the AC current that are observed at a time when the heat amount-equivalent value reaches the first determination heat amount-equivalent value and the restriction is placed.

9. The overheat protection control device for a power converter according claim 1, wherein the power command unit is configured to set a power restriction value which is a value that varies depending on a water temperature of cooling water of the power converter, and, when the power command unit switches the power restriction value, gradually decrease or increase the power restriction value at a slope set in advance.
